(19) United States
(12) Patent Application Publication
(10) Pub. No.: US 2022/0354138 A1
(43) Pub. Date: Nov. 10, 2022

(54) AUTOMATED UNLOADING APPARATUS FOR PORTIONS OF MEAT

(71) Applicant: FAVA S.N.C. DI ADELE TURETTA & C., Parma (PR) (IT)

(72) Inventor: Antonio FAVA, Parma (PR) (IT)

(21) Appl. No.: 17/730,786

(22) Filed: Apr. 27, 2022

(30) Foreign Application Priority Data
May 4, 2021 (IT) 102021000011330

(51) Int. Cl. A22C 17/00; A22C 15/00

(52) U.S. Cl. CPC A22C 17/0093; A22C 15/005; A22C 15/001

(57) ABSTRACT

A method is described for unhooking a portion of meat from a support element to which the portion of meat is hooked, the support element including a plurality of hooks by means of which the portion of meat is hooked to the support element, a bar to which the hooks are rigidly connected by a connection body comprising a first face, from which the hooks rise, and a second face facing in the opposite direction to the first face, and a grasping appendage rising from the second face at least in a direction away from the first face and from the second face. The method includes pulling the grasping appendage in a predetermined extraction direction, and holding the portion of meat, or pushing the portion of meat in a direction opposite to the predetermined extraction direction, at the same time as the step of pulling the grasping appendage in the predetermined extraction direction, completely pulling the hooks off the portion of meat.

### TECHNICAL FIELD

The invention belongs to the technical field of systems for processing portions of meat, for example pork bellies, in which said portions of meat are, for example, cured and/or frozen and/or smoked.

More in detail, the present invention relates to an unloading station adapted to pull, i.e. remove, portions of meat off respective support elements, such as hanging bars.

### PRIOR ART

Plants are known for processing portions of meat, such as cuts of meat having elongated and irregular shape in which two dimensions (width and height) prevail over a third dimension (thickness). A typical cut of meat of that type is a pork belly.

Such plants comprise stations for processing portions of meat, for example smoking stations, salting stations, seasoning stations, refrigeration/freezing stations, etc. In particular, plants for processing pork bellies generally comprise at least one smoking station and one refrigeration/freezing station.

Known plants can also be provided with automated loading stations, configured to load said portions of meat on support elements, or to fix the portions of meat to said support elements, which are then exploited to move the portions of meat within the plant processing stations.

In practice, the portions of meat are moved within the processing stations acting on the support elements to which they are fixed.

A known embodiment of such support elements provides a bar having an elongated shape to which, by means of a connection body, for example in the form of a flat plate, a plurality of needles rising from a face of said support body, in particular from a portion distal from the bar of said face, are connected.

The bar is used as a hold for moving the support element along the plant, while the needles are configured to penetrate the portion of meat and hold it vertically hanging therefrom.

Once the portions of meat have been processed, they must be removed, i.e. unhooked, from the support elements by means of an apparatus for unloading the portions of meat. In practice, at that step, the portions of meat must be pulled off the needles of the respective support elements. This operation can be very complicated when the portions of meat are rigid, for example as a result of a smoking and/or freezing process.

A known solution for unhooking the processed portions of meat from the support elements provides an apparatus for unloading the portions of meat, which is provided with an abutment surface which is put in contact with a portion of meat by moving the support element by means of a specific arrangement for moving the support element. In particular, the support element is moved by placing in contact with the abutment surface a face of the portion of meat which directly contacts a portion of the face of the connection body from which the rectilinear needles rise. When the portion of meat is in such position, the bar of the support element is pushed by the movement arrangement away from the abutment surface, along a direction transverse to the abutment surface, and at the same time a pad is pushed against the face of the connection body from which the needles rise, in a portion of said face between the needles and the bar and proximal to the bar, always in a direction away from the abutment surface.

Thereby, the support element is removed/pulled off from the portion of meat, as the portion of meat cannot advance together with the support element in the direction along which it is pushed by the movement arrangement, and especially by the pad, due to contact with the abutment surface.

Such solution has a drawback. In particular, although the pad is configured to act in a portion of the connection body proximal to the bar, which should be free from the portion of meat, since the shape of such portions of meat is not always regular, if a portion of meat protrudes towards the bar more than normal, when the pad is actuated, this excessively protruding portion of meat will remain squeezed between the pad and the connection body, thus preventing the support element from being removed from the portion of meat. Implementing longer connection bodies of the support elements so that the needles are further away from the bar is not an easy solution, as this would increase the weight of the support elements, having an impact on the power required to move the support elements along the plant (which are generally several thousand in number), as well as on the costs for implementing the support elements themselves.

The object of the present invention is to overcome the constraints of the prior art in the context of a rational and cost-effective solution. Such object is achieved by the features of the invention reported in the independent claim. The dependent claims outline preferred and/or particularly advantageous aspects of the invention.

### DISCLOSURE OF THE INVENTION

In particular, the invention makes available a method for unhooking a portion of meat from a support element to which the portion of meat is hooked, said support element comprising:
a plurality of hooks by means of which the portion of meat is hooked to the support element,
a bar to which said hooks are rigidly connected by means of a connection body comprising a first face, from which said hooks rise, and a second face facing in the opposite direction to the first face, and
a grasping appendage rising from the second face in at least a direction away from the first face and from the second face itself,

said method comprising the steps of:
pulling the grasping appendage in a predetermined extraction direction, and
holding the portion of meat, or pushing the portion of meat in a direction opposite to the predetermined extraction direction, at the same time as the step of pulling the grasping appendage in the predetermined extraction direction, while completely pulling the hooks off the portion of meat.

This method allows the portions of meat to be removed from the support elements more efficiently than the known methods of the prior art, as it is not affected by errors in positioning the pork belly on the support element, leading to excessive overlapping of the portion of meat with the first face, since the extraction of the hooks from the portion of meat does not take place by pushing on the first face to move it away from the portion of meat, but rather by pulling the support element at the second face, so as to move the first face away from the portion of meat.

According to one aspect of the invention, the step of pulling the grasping appendage in the predetermined extraction direction may be performed by means of an automated gripping arrangement.

According to another aspect of the invention, the step of pulling the grasping appendage may be preceded by the steps of:
preparing an abutment body defining an abutment surface
bringing a section of a face of the portion of meat contacting the first face of the connection element into contact with the abutment surface by acting on the bar and/or the grasping appendage,

and wherein the predetermined direction in which the grasping appendage is pulled is in the direction moving away from the abutment surface, and wherein the steps of holding the portion of meat, or pushing the portion of meat in a direction opposite to the predetermined direction in which the grasping appendage is pulled, comprise respectively the step of keeping the abutment surface fixed at a predetermined position in space and the step of moving the abutment surface in a direction opposite to the direction along which the grasping appendage is pulled.

This makes the method particularly effective.

According to another aspect of the invention, the step of bringing a section of the face of the portion of meat contacting the first face of the connection element into contact with the abutment surface by acting on the bar and/or the grasping appendage may be performed by means of an automated movement arrangement configured to move the support element by acting on the bar and/or by means of an automated gripping arrangement configured to grasp and pull the grasping appendage.

According to yet another aspect of the step of bringing a section of a face of the portion of meat contacting the first face of the connection element into contact with the abutment surface by acting on the bar and/or the grasping appendage may be preceded by the step of moving the support element, by acting on its bar, in a predetermined movement direction along a predefined trajectory transverse to a lying plane of the abutment surface and placed at a predetermined distance from the abutment surface, such that the portion of meat moved along this trajectory arrives at a section thereof to contact the abutment surface with its face in contact with the first face of the connection element, said trajectory comprising a first point, upstream of the abutment surface with respect to the predetermined movement direction, and a second point downstream of the abutment surface with respect to the movement direction, and during the movement, the second face of the connection element is kept facing the second point.

According to a further aspect of the invention, the predetermined extraction direction in which the grasping appendage is pulled may be in the direction of approach to the second point of the trajectory.

The invention also makes available another method, i.e. a second method, for unhooking a portion of meat from a support element to which the portion of meat is hooked, said support element comprising:
a plurality of hooks by means of which the portion of meat is hooked to the support element,
a bar to which said hooks are rigidly connected by means of a connection body comprising a first face, from which said hooks rise, and a second face facing in the opposite direction to the first face, and
a grasping appendage rising from the second face in at least a direction away from the first face and from the second face itself,

said method comprising the steps of:
holding the grasping appendage
pushing the portion of meat in a predetermined pushing direction away from the hooks of the support element, at the same time as the step of holding the grasping appendage, completely pulling the hooks off the portion of meat.

This method achieves the same advantages as the first method.

Similarly to the first method, an aspect of the invention provides that the step of holding the grasping appendage may be performed by means of an automated gripping arrangement.

According to another aspect of the invention, the step of holding the grasping appendage may be preceded by the steps of:
preparing an abutment body defining an abutment surface
bringing a section of a face of the portion of meat contacting the first face of the connection element into contact with the abutment surface by acting on the bar and/or the grasping appendage,

and wherein the step of pushing the portion of meat in a predetermined pushing direction away from the hooks of the support element provides moving the abutment body along such predetermined pushing direction.

The invention also makes available an apparatus implementing the first method.

In particular, the invention makes available an automated unloading apparatus for portions of meat configured to unhook a portion of meat from a support element, said support element comprising:
a plurality of hooks capable of penetrating the portion of meat,
a bar to which said hooks are rigidly connected by means of a connection body comprising a first face, from which said hooks rise, and a second face opposite to the first, and
a grasping appendage rising from the second face in at least a direction away from the first face and from the second face itself,

said unloading apparatus being provided with:
an abutment body defining an abutment surface,
a movement arrangement of the support elements, which is of the automated type and is configured to move the at least one support element along a predetermined trajectory transverse to a lying plane of the abutment surface and placed at a predetermined distance from the abutment surface such that the portion of meat moved along said trajectory comes into contact with the feedback surface, and wherein the movement arrangement is configured to move the support element along said trajectory in a predetermined direction, at least from a first point of the trajectory, upstream of the abutment surface with respect to the predetermined movement direction, to a second point of the trajectory, and a second point downstream of the abutment surface with respect to the movement direction and wherein the movement arrangement is configured to keep the second face of the connection body, facing the second point,
a gripping arrangement positioned in proximity to the abutment surface and provided with a gripping body configured to grasp the grasping appendage and a drive of the gripping body configured to move the gripping body into a grasping position, in which the gripping body grasps the grasping portion, and to subsequently pull the gripping body, in a predetermined extraction direction that is away from the abutment surface extracting the hooks from the portion of meat that is held in contact with the abutment surface.

Thanks to this solution, an apparatus for unloading the portions of meat is made available which is more efficient than the apparatuses of the prior art, as it is not affected by errors in positioning the pork belly on the support element, leading to excessive overlapping of the portion of meat with the first face, since the extraction of the hooks from the portion of meat does not take place by pushing on the first face to move it away from the portion of meat, but rather by pulling the support element at the second face, so as to move the first face away from the portion of meat.

According to an aspect of the invention, the gripping arrangement may be configured to only grasp the grasping appendage.

According to another aspect of the invention, the apparatus may comprise a sensor configured to monitor a parameter indicative of the presence of the support element in proximity to a lying plane of the abutment surface, and an electronic control and command unit operatively connected to said sensor and the gripping arrangement and configured to activate the drive to move the gripping body into the grasping position when it detects through the sensor the presence of the support element at a predetermined distance from the abutment surface.

Thereby, a particularly efficient and precise apparatus is made available.

According to another aspect of the invention, the apparatus may comprise a pushing body, placed in proximity to the abutment surface and selectively movable at least in a position where it prevents a movement of the support element towards the first point of the trajectory by acting on the bar.

The support element is thereby prevented from retracting during the grasping operation by the gripping arrangement, which could result in a failure or defective grasping.

According to a still further aspect of the invention, the gripping body may comprise an abutment body and the pushing body may also be driven, when it is in the position wherein it prevents the support element from moving towards the first point of the trajectory, towards the second point of the trajectory so as to push the grasping appendage against said abutment body.

This always ensures correct positioning of the grasping appendage regardless of the thickness of the portion of meat, as also shown in FIGS. 2 and 9.

According to a further aspect of the invention, the gripping body may be shaped like a hook and may be adapted to grasp the grasping appendage by hooking it.

A further aspect of the invention provides that the appendage may comprise a recess or slot, preferably a plurality of recesses or slots, and the gripping arrangement comprises a body shaped like a hook and adapted to be inserted at least partially into the recess or slot in order to grasp the grasping appendage.

The invention may also provide that the drive of the gripping body may be configured to move the gripping body along a curvilinear trajectory.

Grasping is thereby made easier by minimising pushing on the support element towards the first position.

The invention may further provide that the gripping arrangement comprises a slide to which the gripping body may be hinged with respect to a hinge axis, a spring provided with a first end connected to the slide and an opposite second end connected to the gripping body, and the drive of the gripping arrangement is configured to move the slide along a rectilinear trajectory.

The drive of the gripping body is thereby particularly simplified, as a single linear actuator is sufficient to move the whole thing along a rectilinear trajectory, since the particular configuration of the gripping body which is hinged and connected with a spring, enables the automatic insertion of the hook of the gripping body into the recess or through-slot.

The invention may further provide that the apparatus may comprise an upper abutment superimposed in plan on the abutment body and adapted to upperly limit a vertical movement of the bar when the holding appendage is pulled (although shown in just one embodiment it may also be implemented by the other embodiments).

Another aspect of the invention may provide that the hooks are shaped like rectilinear needles and arranged with longitudinal axes parallel to each other, and that the pushing direction may be parallel to the longitudinal axes of the needles.

It is thereby possible to reduce the bending moments in the support element and the needle rotations with respect to the bar, so a lower force is required for extraction (actuators can be smaller and more compact) and damage to the portion of meat due to needle extraction (which would be greater in the case of rotations of the support element) is minimised.

Still another aspect of the invention provides that the slot or recess may be aligned with a plane on which the longitudinal axes of the needles lie.

This feature allows for an optimum distribution of the pulling forces.

The invention may also provide that the movement arrangement may be configured to move the support element towards the second point while the gripping arrangement simultaneously pulls the appendage.

It is thereby possible to increase the hourly productivity, as the movement of the support element is not interrupted while the appendage is being pulled.

The invention also makes available an apparatus implementing the second method. In particular, the invention makes available an automated unloading apparatus for portions of meat configured to unhook a portion of meat from a support element, said support element comprising:
a plurality of hooks capable of penetrating the portion of meat,
a bar to which said hooks are rigidly connected by means of a connection body comprising a first face, from which said hooks rise, and a second face opposite to the first, and
a grasping appendage rising from the second face in at least a direction away from the first face and from the second face itself,

said unloading apparatus being provided with:
an abutment body defining an abutment surface,
a movement arrangement of the support elements, which is of the automated type and is configured to move the at least one support element along a predetermined trajectory transverse to a lying plane of the abutment surface and placed at a predetermined distance from the abutment surface such that the portion of meat moved along said trajectory comes into contact with the feedback surface, and wherein the movement arrangement is configured to move the support element along said trajectory in a predetermined direction, at least from a first point of the trajectory, upstream of the abutment surface with respect to the predetermined movement direction, to a second point of the trajectory, and a second point downstream of the abutment surface with respect to the movement direction and wherein the movement arrangement is configured to keep the second face of the connection body, facing the second point,
a gripping arrangement positioned in proximity to the abutment surface and provided with a gripping body configured to (only) grasp the grasping appendage, and
a drive of the abutment body configured to move the abutment body in a predetermined pushing direction approaching the first point, extracting the hooks from the portion of meat which is pushed while the support element is held in a predetermined position of the gripping arrangement.

According to one aspect of the invention, in this case as well, the gripping arrangement may be configured to only grasp the grasping appendage.

According to another aspect of the invention, the apparatus may comprise a sensor configured to monitor a parameter indicative of the presence of the support element in proximity to a lying plane of the abutment surface, and an electronic control and command unit operatively connected to said sensor and to the gripping arrangement and configured to activate the drive in order to move the abutment body in the predetermined pushing direction when it detects, by means of the sensor, the presence of the support element at a predetermined distance from the abutment surface.

Thereby, a particularly efficient and precise apparatus is made available.

According to another aspect of the invention, the apparatus may comprise a pushing body, placed in proximity to the abutment surface and selectively movable at least in a position where it prevents a movement of the support element towards the first point of the trajectory by acting on the bar.

The support element is thereby prevented from retracting during the grasping operation by the gripping arrangement, which could result in a failure or defective grasping.

According to a still further aspect of the invention, the gripping body may comprise an abutment body and the pushing body may also be driven, when it is in the position wherein it prevents the support element from moving towards the first point of the trajectory, towards the second point of the trajectory so as to push the grasping appendage against said abutment body.

This always ensures a correct positioning of the grasping appendage regardless of the thickness of the portion of meat.

According to a further aspect of the invention, the gripping body may be shaped like a hook and may be adapted to grasp the grasping appendage by hooking it.

A further aspect of the invention provides that the appendage may comprise a recess or slot, preferably a plurality of recesses or slots, and the gripping arrangement comprises a body shaped like a hook and adapted to be inserted at least partially into the recess or slot in order to grasp the grasping appendage.

The invention may further provide that the gripping arrangement comprises a slide to which the gripping body may be hinged with respect to a hinge axis, a spring provided with a first end connected to the slide and an opposite second end connected to the gripping body, and the drive of the gripping arrangement is configured to move the slide along a rectilinear trajectory.

The drive of the gripping body is thereby particularly simplified, as a single linear actuator is sufficient to move the whole thing along a rectilinear trajectory, since the particular configuration of the gripping body which is hinged and connected with a spring, enables the automatic insertion of the hook of the gripping body into the recess or through-slot.

The invention may further provide that the apparatus may comprise an upper abutment superimposed in plan on the abutment body and adapted to upperly limit a vertical movement of the bar when the holding appendage is pulled (although shown in just one embodiment it may also be implemented by the other embodiments).

Another aspect of the invention may provide that the hooks are shaped like rectilinear needles and arranged with longitudinal axes parallel to each other, and that the pushing direction may be parallel to the longitudinal axes of the needles.

It is thereby possible to reduce the bending moments in the support element and the needle rotations with respect to the bar, so a lower force is required for extraction (actuators can be smaller and more compact) and damage to the portion of meat due to needle extraction (which would be greater in the case of rotations of the support element) is minimised.

Still another aspect of the invention provides that the slot or recess may be aligned with a plane on which the longitudinal axes of the needles lie.

This feature allows for an optimum distribution of the pulling forces.

### BRIEF DESCRIPTION OF THE DRAWINGS

Further features and advantages of the invention will be more apparent after reading the following description provided by way of non-limiting example, with the aid of the accompanying drawings.

FIG. 1 is a schematic side view of an unloading apparatus for portions of meat according to a first embodiment of the invention and shown in a resting operating position.

FIG. 2 is a schematic side view of the unloading apparatus of FIG. 1 shown in an operating position subsequent to the one shown in FIG. 1.

FIG. 3 is a schematic side view of the unloading apparatus of FIG. 1 shown in an operating position subsequent to the one shown in FIG. 2 and definable as a grasping operating position.

FIG. 4 is a schematic side view of the unloading apparatus of FIG. 1 shown in an operating position subsequent to the one shown in FIG. 3 and definable as the end-of-pulling operating position.

FIG. 5 is a schematic side view of the unloading apparatus of FIG. 1 shown in an operating position subsequent to the one shown in FIG. 4.

FIG. 6 is a partial axonometric and schematic view of a first embodiment of a support element according to the invention and which is used in the apparatus of the preceding figures. The support element is adapted to allow a portion of meat to be hooked thereto.

FIG. 7 is a partial axonometric and schematic view of an abutment body of the apparatus of the preceding Figures.

FIG. 8 is a partial axonometric and schematic view of a gripping body of the apparatus of the previous Figures.

FIG. 9 is a view comparing two operating positions that the support element and the gripping body of the apparatus of the preceding figures can reach as the thickness of the portion of meat hooked to the gripping element varies.

FIG. 10 is a schematic side view of an unloading apparatus for portions of meat according to a second embodiment of the invention and shown in a resting operating position.

FIG. 11 is a schematic side view of an unloading apparatus for portions of meat according to a third embodiment of the invention and shown in a resting operating position.

FIG. 12 is a schematic side view of an unloading apparatus for portions of meat according to a fourth embodiment of the invention and shown in a grasping operating position.

FIG. 13 is a plan view of the apparatus of FIG. 12.

FIG. 14 is a schematic side view of an unloading apparatus for portions of meat according to a fifth embodiment of the invention and shown in a grasping operating position.

FIG. 15 is a schematic side view of the apparatus of FIG. 14 shown in an operating position subsequent to the one of FIG. 14 and definable as the end-of-pushing operating position.

FIG. 16 is a front axonometric view of a second embodiment of the support element according to the invention.

FIG. 17 is a rear axonometric view of the support element of the preceding Figure.

FIG. 18 is a side view of the support element of FIGS. 16 and 17.

FIG. 19 is a front axonometric view of a third embodiment of the support element according to the invention. Such embodiment of the support element is used in the apparatuses shown in FIGS. 12-15.

FIG. 20 is a rear axonometric view of the support element of the preceding Figure.

FIG. 21 is a side view of the support element of FIGS. 19 and 20.

FIG. 22 is a front axonometric view of a fourth embodiment of the support element according to the invention.

FIG. 23 is a rear axonometric view of the support element of the preceding Figure.

FIG. 24 is a side view of the support element of FIGS. 22 and 23.

FIG. 25 is a rear axonometric view of a fifth embodiment of the support element according to the invention.

FIG. 26 is a side view of the support element of FIG. 25.

FIG. 27 is a view comparing three operating positions that the support element can reach, when it is moved on a flat surface and has a bar having a circular cross-section (first embodiment of the bar according to the invention), as the thickness of the portion of meat hooked to the gripping element varies. In particular, the first image from the left of the set shows an optimal thickness condition, i.e. within the predefined range, the second image shows a condition where the thickness is below the optimal range and the third image on the right shows a condition where the thickness is above the optimal range.

FIG. 28 is a schematic side view of a second embodiment of the bar of the support element.

FIG. 29 is a schematic side view of a third embodiment of the bar of the support element.

FIG. 30 is a schematic side view of a fourth embodiment of the bar of the support element.

FIG. 31 is a schematic side view of a fifth embodiment of the bar of the support element.

FIG. 32 is a schematic side view of a sixth embodiment of the bar of the support element.

FIG. 33 is a schematic side view of a seventh embodiment of the bar of the support element.

FIG. 34 is a schematic side view of an eighth embodiment of the bar of the support element.

FIG. 35 is a schematic block view of a plant for processing portions of meat provided with any one of the embodiments of unloading apparatus shown.

FIG. 36 is a schematic side view of a sixth embodiment of the bar according to the invention.

FIG. 37 is a partial axonometric and schematic view of the sixth embodiment of the bar of FIG. 36.

### BEST MODE TO IMPLEMENT THE INVENTION

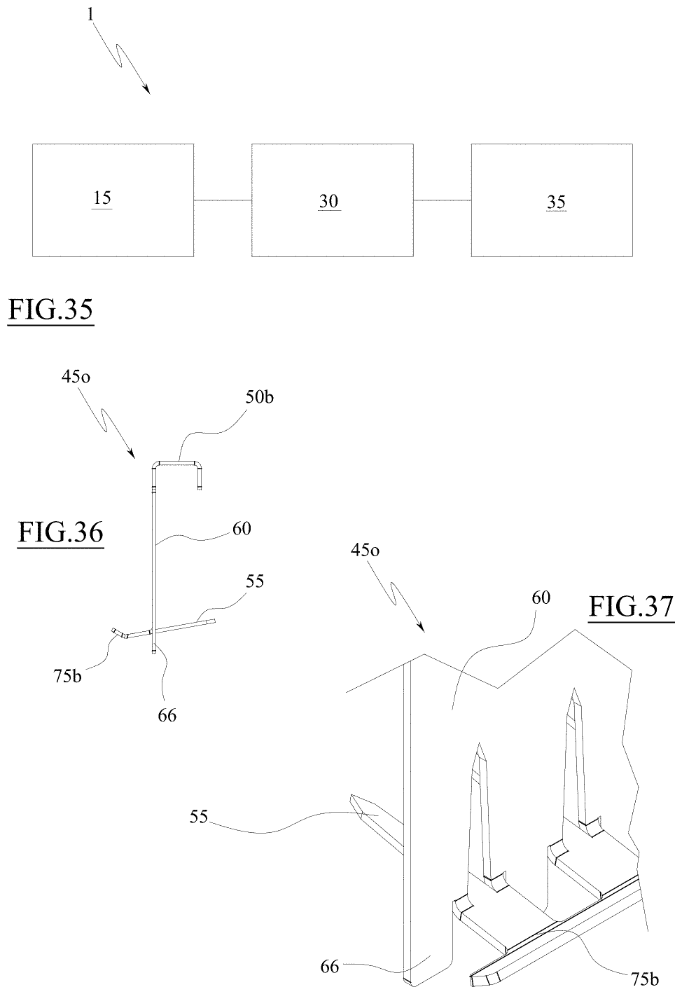

In FIG. 35 an automated processing plant 1 for processing portions of meat 10, such as pork bellies, has been schematically shown, for merely exemplary purposes.

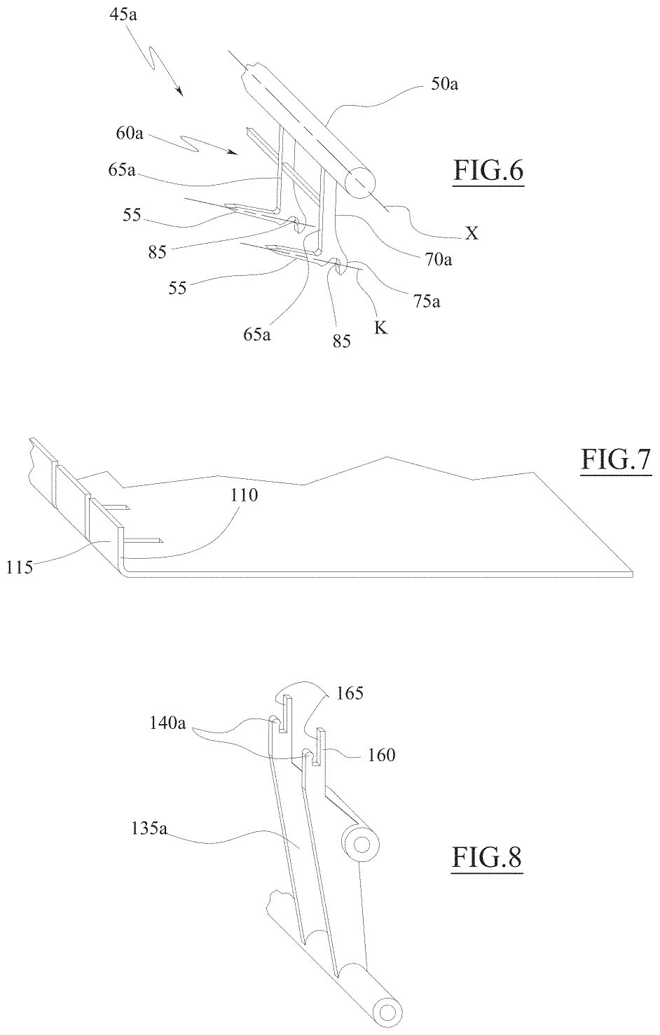

Such an automated plant 1 comprises a station 15 for loading portions of meat, of the automated type, which is configured to load, i.e. hook, the portions of meat 10 onto support elements (FIGS. 6, 16-34). In particular, as will be described below, these support elements are provided with hooks and the loading station is configured to insert said hooks into the portions of meat to secure them to the support element.

Depending on the size of the portion of meat and the support element, i.e. the number of hooks, one or more portions of meat can be hooked to a single support element.

The portions of meat are preferably elongated and irregular in shape, with two dimensions (width and height) prevailing over a third dimension (thickness), and in which it is therefore possible to identify a first major face 20 and a second major face 25 opposite to the first face and spaced from it by an amount equal to the third dimension, i.e. The thickness. The thickness is generally not regular. A typical portion of meat of that type is a pork belly.

The support elements are used to move the portions of meat 10 within the processing plant. In particular, the plant may comprise means for moving portions of meat throughout the plant that act directly on the support elements.

The processing plant 1 comprises one or more processing stations 30 positioned downstream of the loading station 15 with respect to the direction of a work flow of the portions of meat 10 within the processing plant. For instance, said processing plant 1 comprises a cooking/smoking station positioned downstream of the loading station 15 and a freezing or chilling station (positioned downstream of the smoking station).

The portions of meat 10 are moved throughout the smoking station and freezing or chilling station, by means of the support elements.

The system also comprises, downstream of the processing station, or stations, an unloading station 35 configured to remove/unhook the portions of meat from the support elements, or in other words to pull the portions of meat off the hooks of the support element, and to direct the detached portions of meat to further processing stations, such as cutting stations, and/or packaging stations. In particular, the unloading station 35 comprises an unloading apparatus 40a, 40b, 40c, 40d, 40e configured to unhook the portions of meat from the support elements.

In the Figures, a plurality of embodiments of support elements 45a, 45b, 45c, 45d, 45e, 45f, 45g, 45h, 45i, 45l, 45m, 45n suitable for the unloading apparatus according to the invention, or for at least one of the embodiments of the unloading apparatus according to the invention, are shown. Hereinafter, when a characteristic is common to all apparatuses or support elements, only number 40 and number 45 will be respectively used for sake of brevity.

In particular, all the support elements 45 comprise a bar 50a, 50b, 50c, 50d, 50e, 50f, 50g, 50h, 50i, 50l, 50m, 50n which extends (mainly) longitudinally along a longitudinal axis X, adapted to be directly contacted by the plant movement means (only the bar is contacted by said means for moving the support elements throughout the plant and the stations thereof), a plurality of hooks 55, preferably distributed along a row parallel to the longitudinal axis X (or a plurality of rows parallel to the longitudinal axis X, adapted to penetrate the portion of meat, and a connection body 60a, 60b, 60c, 60d, 60e connecting (directly) the hooks to the bar and comprising a first face 65a, 65b, 65c, 65d, 65e, from which said hooks of the support element, i.e. all the hooks of the support element, rise, and a second face 70a, 70b, 70c, 70d, 70e facing in the opposite direction to the first face. Hereinafter, when a characteristic is common or applicable to all bars or all connection bodies or all first faces or all second faces, the numbers will be simplified to 50, 60, 65 and 70.

In addition, all the support elements share the fact that they are configured to be grasped and pulled or held, in order to extract/pull the hooks off the portions of meat, acting (only) at the second face 70. In particular, while the support element is being pulled or held at the second face, the portion of meat is prevented from following the trajectory imposed by such pulling, by means of an abutment surface of the unloading apparatus, or the portion of meat is pushed in the direction moving away from the support element while the latter is held in place so as to pull off the hooks, as will become clearer hereinafter.

In order to be grasped and pulled from the second face, all the embodiments of the support element 45 comprise a grasping appendage 75a, 75b, 75c, 75d, 75e, possibly made in single body with the connection body 60, which protrudes from the second face 70 at least in one direction away from the first face (and from the second face itself).

Also the grasping appendage, when talking about the characteristics common to all the embodiments thereof, will be referred to by number 75.

The grasping appendage 75 is in contact only with the second face 70, i.e. it does not contact the other elements of the support element itself. In practice, the grasping appendage comprises a free end that is distal from the second face 70 and the first face 65. The entire grasping appendage rises all the time and only in the direction away from the first face.

Such moving-away direction is also perpendicular to an imaginary plane on which the longitudinal axis X lies.

Still more in detail, the moving-away direction is opposite to a direction which the first face is facing, i.e. it is opposite to a direction towards which the hooks extend by rising from the first face.

The grasping appendage is rigidly fixed to the connection body at the second face so that forces, e.g. the pulling force, can be transferred from the appendage to the connection body and thus to the hooks. The grasping appendage is also fixed without residual degrees of freedom in relation to the second face of the connection body. The grasping appendage may therefore be made in a single body with the connection body (as in the embodiment shown) or it may be welded to the second face of the connection body, or it may be screwed or bolted to the second face of the connection body.

Also in all the embodiments of the support elements, in order to reduce the generation of bending moments of the connection body, therefore in order to reduce the thicknesses and weight of the connection body, the grasping appendage 75 rises from a portion of the second face 70 proximal to the hooks 55. More in detail, the grasping appendage rises from a portion of the second face placed at a (minimum) distance from the bar 50 substantially equal to a (minimum) distance of the portion of the first face from which the hooks rise, i.e. at least one hook (such distance being measured along a plane perpendicular to the longitudinal axis X of the bar 50).

It should be specified that substantially means also that the (minimum) distance from the bar of the portion of the second face from which the grasping appendage rises is between 0.7 and 1.3 times, preferably between 0.9 and 1.1 times the (minimum) distance from the bar of the portion of the first face from which the hooks rise, i.e. at least one hook.

Still in order to reduce the generation of bending moments in the connection body, such distances, exclusive of the manufacturing tolerances, are, still more preferably, equal.

These distances may also be related to a central axis of the bar, which, depending on the shape of the bar, may be a longitudinal axis of symmetry or a longitudinal axis passing through the centre of gravity of the bar (centre of gravity of the bar alone, isolated from the rest of the support element).

In all the embodiments of the support elements, the connection body 60 has a thickness, measured in a plane perpendicular to the longitudinal axis and along a direction perpendicular to the distance between the portion of the first face from which the hooks rise and the bar, which is very small compared to its extension from the hooks to the bar itself. For example, such thickness is less than one-third, preferably one-sixth, of the extension of the connection body between the hooks 55 and the bar 50.

In order to improve the distribution of forces and to reduce the bending moments in the connection body, the grasping appendage 75 extends predominantly, in addition to the moving-away direction, also in a longitudinal direction parallel to the longitudinal axis X of the bar and is rigidly integral with the second face 70 in at least a plurality of sections of the portion of the second face from which the grasping appendage itself rises, which sections are placed side by side along said longitudinal direction along which the appendage extends. In particular, there is at least one of said sections every two consecutive hooks.

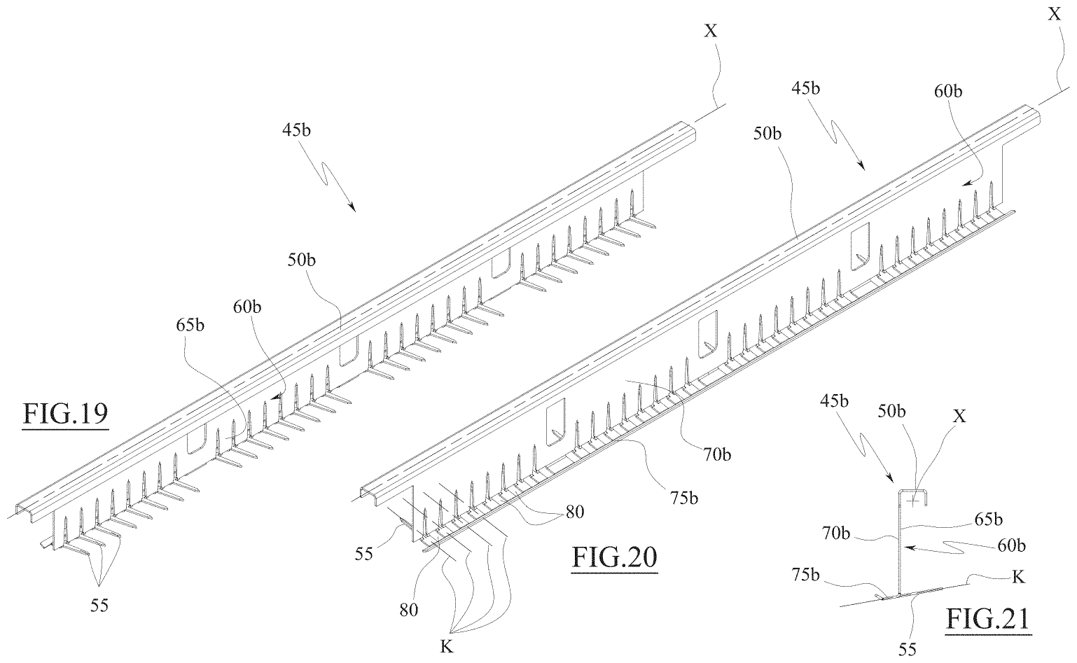

Preferably there is at least one of said sections per hook, for example in the embodiments shown in FIGS. 19 to 24 there are two sections per hook, preferably placed one to the right and one to the left of the hook with respect to the longitudinal direction parallel to the axis X.

At these sections the grasping appendage 75 is rigidly fixed to the connection body and the second face so that forces, for example the pulling force, can be transferred from the appendage to the connection body and the hooks. The grasping appendage is also fixed without residual degrees of freedom to the second face of the connection body at such sections. The grasping appendage in such sections can therefore be made in one piece with the connection body (as in the embodiments shown) or it can be welded to the second face of the connection body in such sections, or it can be screwed or bolted to the second face of the connection body in such sections. In other words, since in all of the embodiments shown, the hooks, the connection body and the grasping appendage are made as a single body, it is also possible to say that all of the hooks extend from the grasping appendage, being the connection body in proximity to the grasping appendage similar to the grasping appendage itself.

It may further be said that the sum of the longitudinal extensions of said sections measured along a direction parallel to the longitudinal axis of the bar is at least equal to half a length of the row of hooks.

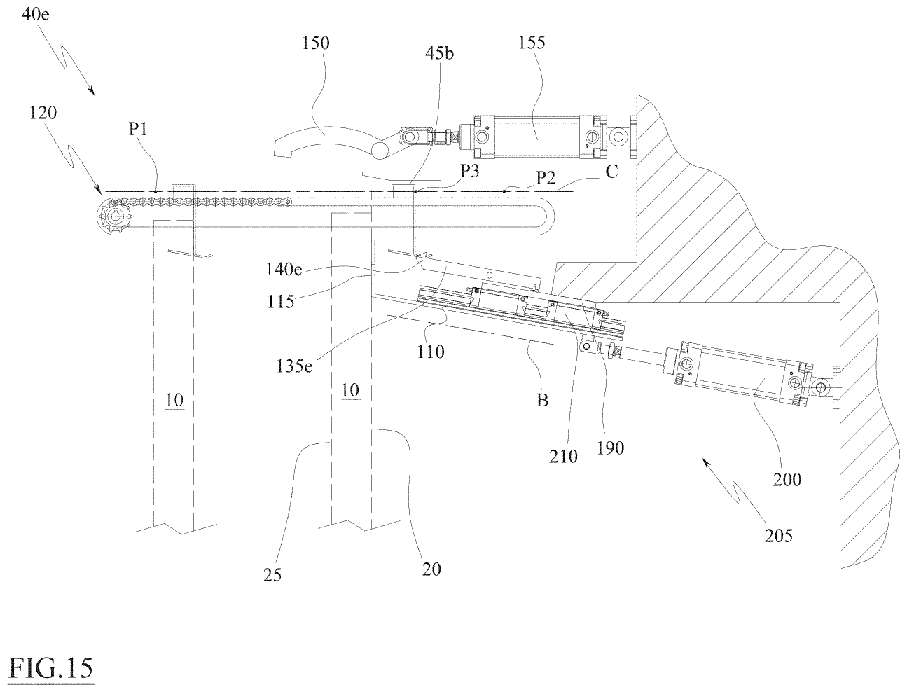

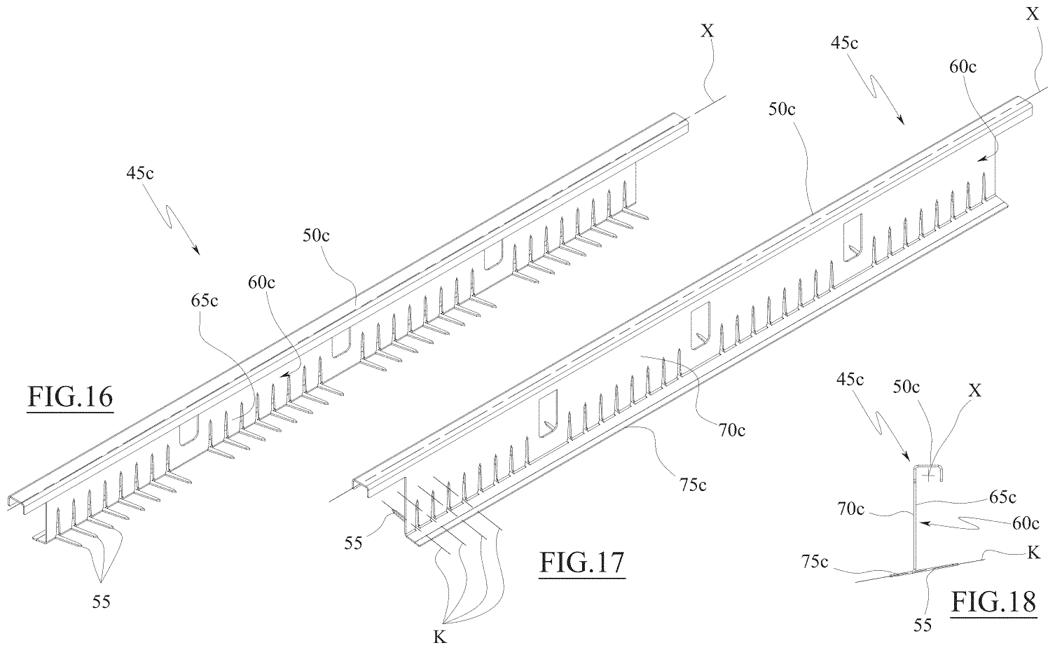

In the embodiment shown in the FIGS. 16 to 18, these sections form a single continuous section extending throughout the extension of the row of hooks.

In addition, in the embodiments shown, the size of the grasping appendage in the longitudinal direction is at least equal to half a length (measured along a direction parallel to the longitudinal axis X) of the row of hooks, preferably it is equal to the length of the row of hooks.

The hooks 55 are rigidly fixed without residual degrees of freedom to the first face of the connection body. For example, they may be made in a single piece with the connection body.

The hooks 55 are rigid, i.e. they cannot be bent under the normal working loads for which they are designed.

The hooks 55 are preferably shaped as rectilinear needles rising from the first face and in particular are arranged with respective longitudinal axes K parallel to each other (and lying individually in planes perpendicular to the longitudinal axis X), for example lying together on the same plane (parallel to the longitudinal axis X).

Said rectilinear needles are all distributed and aligned along a row parallel to the longitudinal axis X or a plurality of rows spaced apart from each other and parallel to such longitudinal axis.

In the detail of their shape, said rectilinear needles comprise a base, rigidly fixed without residual degrees of freedom to the first face, from which a rod-shaped body, terminating in a pointed end, for example conical, develops along the longitudinal axis K. The longitudinal axes K substantially coincide with the central axes of the rod-shaped bodies.

The longitudinal axes K of the rectilinear needles are perpendicular to a plane on which the longitudinal axis X lies.

Still in order to reduce bending forces, when the hooks are rectilinear needles, the portion of the second face from which the grasping appendage rises is made in proximity to a plane on which the longitudinal axes K of the needles lie.

For example, the minimum distance of said portion of the second face from said plane is less than 0.2 times the distance of said plane from the longitudinal axis X.

Preferably, said portion of the second face from which the grasping appendage rises intersects the lying plane of the longitudinal axes K of the hooks.

In addition, the direction away from the needles along which it extends is parallel to the longitudinal axes k of the needles. Accordingly, if the portion of the second face, i.e. the sections of the second face, from which the grasping appendage rises, is intersected by the lying plane of the longitudinal axes K and the moving-away direction is parallel to that plane, the grasping appendage is intersected by the lying plane of the longitudinal axes K both at the second face and at one end of the grasping appendage distal from the second face.

Regardless of the orientation of the moving-away direction, of the exact position of the second face from which the grasping appendage extends, and also regardless of whether the hooks are rectilinear needles, the grasping appendage 75a, 75b, 75d, 75e may comprise a through-slot 80 or a recess 85, for example it may comprise a plurality of through-slots 80 or a plurality of recesses 85 aligned with each other along a direction parallel to the direction of the longitudinal axis X. This feature improves the grasping (presence of slots or recesses). The fact that there is a plurality of them improves the distribution of forces.

For example, for a better distribution of forces, at least one through-slot or recess is provided for every two hooks 55, i.e. rectilinear needles. In the embodiments shown, there is a through-slot or recess for each hook 55, i.e. rectilinear needle. When the hooks are rectilinear needles, the plurality of through-slots or the plurality of recesses are made in the grasping appendage in proximity to the plane on which the longitudinal axes K of the needles lie.

For example, the minimum distance of the through-slot or recess from said plane is less than 0.2 times the distance of said plane from the longitudinal axis X. Preferably, the recess or through-slot, or said through-slots or recesses, are intersected by the lying plane of the longitudinal axes K of the needles.

The recesses 85 are shaped as grooves. In particular, grooves that have a concave surface provided with an axis of curvature parallel to the longitudinal axis. Furthermore, such concave portion comprises a first portion proximal to the second face 70a, 70e and an adjoining second portion distal from the first face, and the second portion intersects the moving-away direction, i.e. intersects the lying plane of the longitudinal axes K of the rectilinear needles.

The through-slots 80, which may also be described as through-holes, are arranged with a respective central axis transverse to the moving-away direction, for example transverse, preferably perpendicular, to the lying plane of the longitudinal axes K. In particular, each through-slot 80 comprises a first portion proximal to the second face 70b, 70d and a second portion distal therefrom, and the second portion intersects the moving-away direction, i.e. intersects the lying plane of the longitudinal axes K of the rectilinear needles.

In the embodiment shown in FIGS. 16-18, the grasping appendage 70c has no slots or recesses, i.e. it is a seamless body. For example, it is a flat seamless plate, alternatively it may be a convex and seamless body.

This type of grasping appendage, which cannot be hooked for grasping, must be grasped by means of a gripper clamping the grasping appendage 70c.

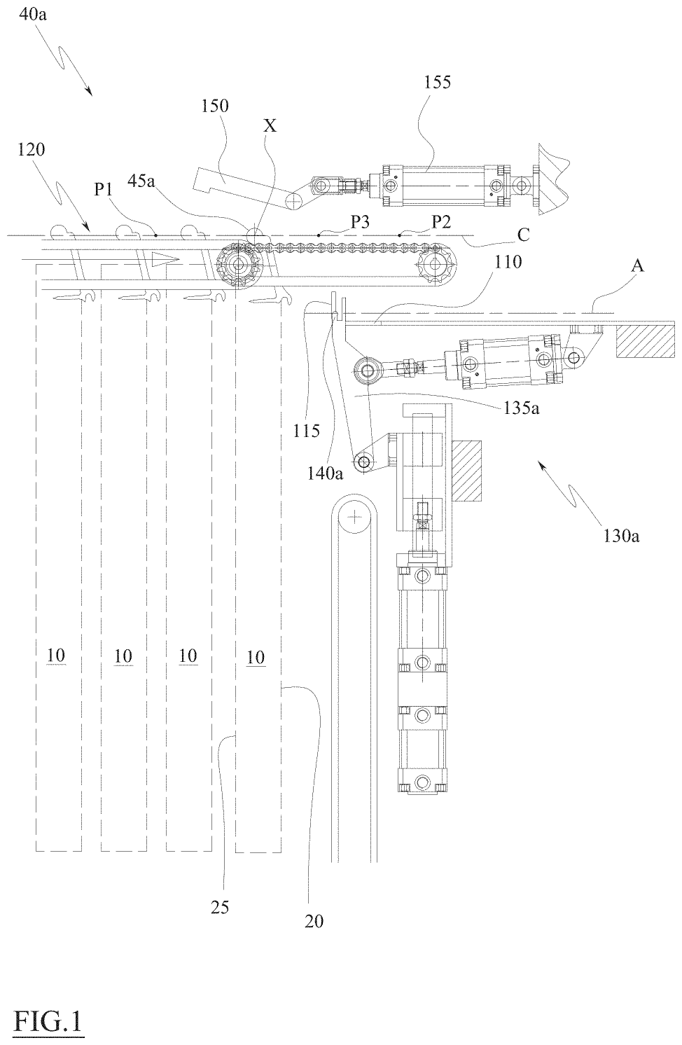

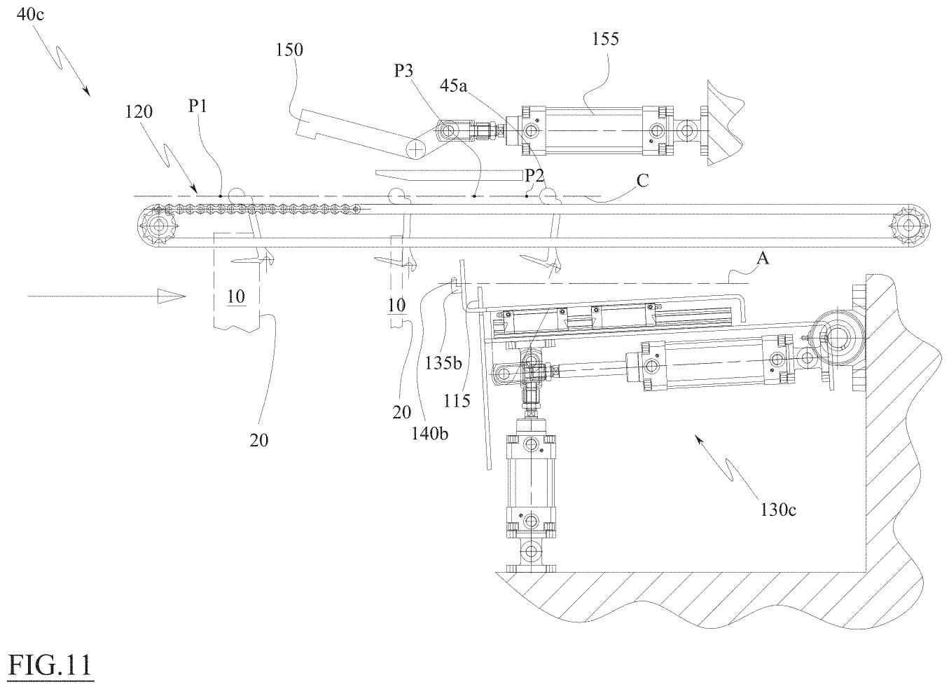

The grasping appendage may be made in a plurality of appendage bodies mechanically independent of each other, as for example in the embodiments shown in FIGS. 1-6, 9-11, 25, 26. In practice, these appendage bodies are connected to each other only by their independent connection to the connection body. In other words, these appendage bodies are not directly connected or in contact with each other.

Each appendage body therefore rises independently of the others from a respective section of the second face, the second sections being spaced apart from each other.

Such appendage bodies may be aligned with each other along a direction parallel to the longitudinal axis X. In addition, two appendage bodies that are adjacent to each other are separated by a gap which extends from the second face.

When there are a plurality of appendage bodies, preferably each appendage body comprises a respective single through-slot or a respective single recess, such as in the embodiment shown in FIGS. 1-6, 9-11, 25, 26 wherein each appendage body comprises a respective recess 85.

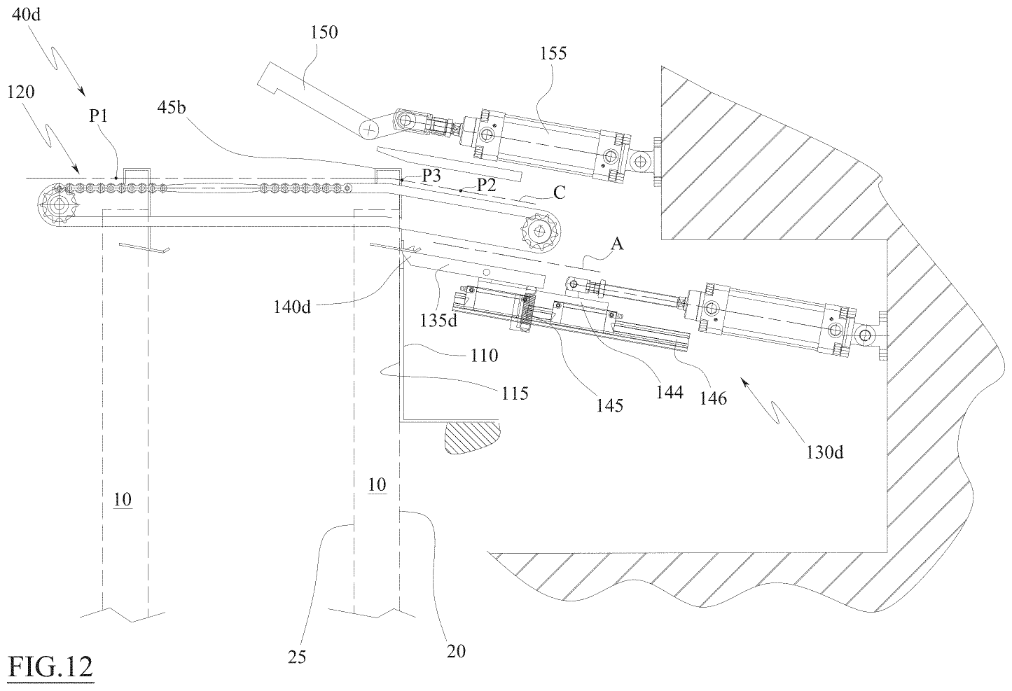

In the embodiments shown in FIGS. 12-15 and 19-24, on the other hand, a grasping appendage 75b, 75d formed in a single body, i.e. a single appendage body, e.g. connected to the second face 70b, 70d in the plurality of sections of the second face, is shown.

Such single appendage body comprises an end edge that is opposite to the second face and is continuous, i.e. seamless, throughout the extension of the appendage body itself.

Such single appendage body, in the embodiments shown in FIGS. 12-15 and 19-24, may also be seen as a plurality of appendage bodies rigidly connected directly to each other at their respective portions distal from the second face.

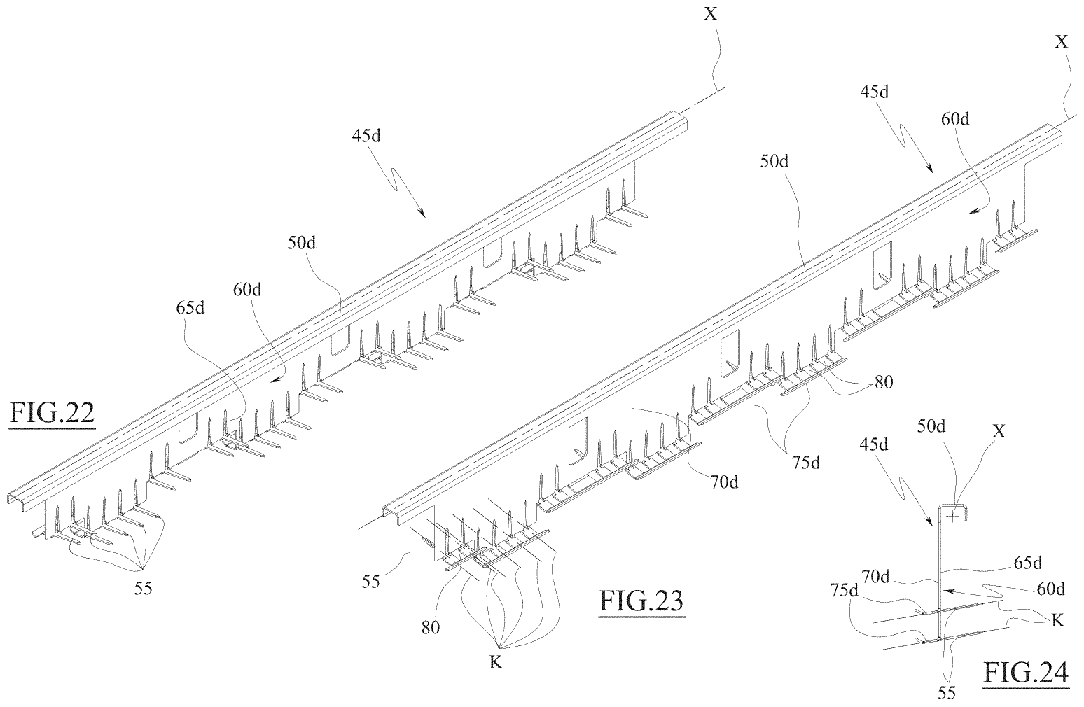

In case there are a plurality of rows of hooks arranged at different distances from the bar, the above set-forth concepts apply for each row of hooks, as shown in the embodiment of FIGS. 22-24. In particular, in such a case, the support element may preferably comprise for each row of hooks a respective grasping appendage, which rises from a portion of the second face proximal to said respective row of hooks and extends in a direction away from the first face and the second face itself. All the considerations made above about the possible characteristics that the grasping appendage may have apply to such a grasping appendage.

In addition, in case of a single body, in the embodiments shown in FIGS. 12-15 and 19-24, there are a plurality of through-slots 80, and not recesses, aligned along a direction parallel to the longitudinal axis X (arranged at regular intervals).

In addition, in such embodiments, the hooks originate from a space of the single body of the branching appendage between two adjacent slots, as the support elements shown there are made by cutting and bending a single metal sheet.

All the embodiments share the fact that the bar 50 has a longitudinal extension greater than the length of the row of hooks (needles) and/or of the connection body along a direction parallel to the longitudinal axis X, in case the connection body extends longitudinally more than the row of needles.

In particular, the bars each comprise a pair of opposite longitudinal ends which protrude longitudinally with respect to the connection body, for example by a same amount.

The bar shown in the different embodiments is not necessarily the one shown in the precise embodiment of the support element, but may also be any one of the bars of the other embodiments, at least at the longitudinal ends.

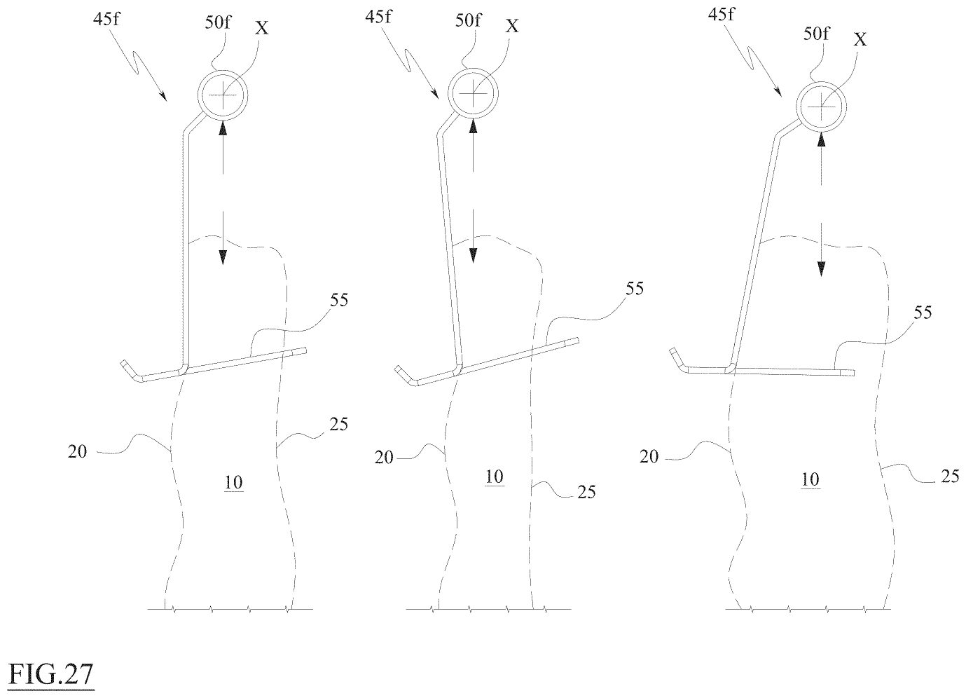

In particular, in all the embodiments shown, the bar may be shaped like any one of the bars shown in FIGS. 27-34, at least at the longitudinal ends. As will be clear hereinafter, the peculiarities of such bars are independent of the fact that the hooks are made as rectilinear needles, and can enjoy independent protection even with respect to the precise positioning of the grasping appendage rigidly integral with the second face in at least a plurality of sections placed side by side along said longitudinal direction along which the grasping appendage extends, and in which there is at least one of said sections every two consecutive needles.

The shape of the bar in the portion comprised between the longitudinal ends is of relative importance for the purposes of the present invention, whereas the shape of the longitudinal ends is more important.

For example, the bar may have, at least at the longitudinal ends, a cross-section (with respect to the longitudinal axis X) having a circular shape, as in the embodiments shown in FIGS. 1-11 and 27. In particular, the longitudinal ends may be cylindrical.

Preferably, the bar may have, at least at the longitudinal ends, a flat surface 90g, 90h (forming part of an outer surface of the bar, i.e. an outer surface of the longitudinal ends) lying in a plane parallel to the longitudinal axis and having a length in a direction transverse to the longitudinal axis of at least 0.6 times the length of a hook, or needle, of the plurality of hooks, measured along a longitudinal axis of the hook, or along the longitudinal axis K of the needle. In addition, the flat surface 90g, 90h faces the hooks and lies in a plane parallel to the longitudinal axis X.

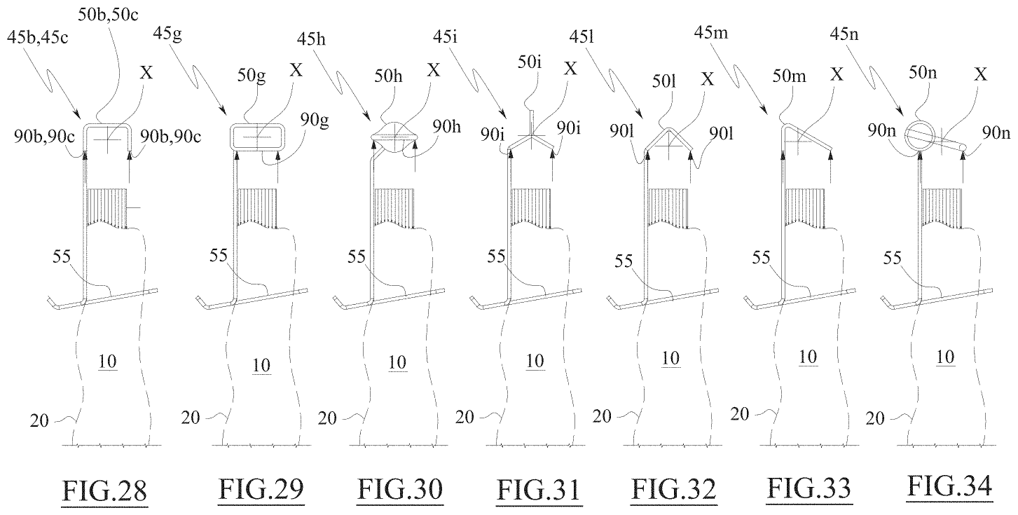

This makes it possible to increase, compared to the bar with cylindrical longitudinal ends, a range of thicknesses of the portions of meat in which the support element does not rotate around the bar. In particular, as can be seen by comparing FIG. 27 with FIGS. 28-34, in case the bar has cylindrical longitudinal ends, when the thickness of the belly is above or below the range for which the support element is designed, the bar tends to rotate, leading to excessive inclinations of the needles and variations in the position of the portion of meat, which may create problems when used in automated systems. The bar with flat ends, on the other hand, allows this range to be widened.

Embodiments of this type of bar are shown in FIGS. 29 and 30, where in the first one, the bar has a rectangular outer surface (in cross-section with respect to the longitudinal axis K) and in the second one, the bar is round with flat (flattened) ends.

The same advantage is obtained if the bar has, or at least its longitudinal ends each have, a pair of flat surfaces 90b, 90c, or a pair of curved surfaces 90n, extending longitudinally parallel to the longitudinal axis X and tangent to the same plane parallel to the longitudinal axis X and spaced apart in a direction transverse to the longitudinal axis X by an amount at least equal to 0.6 times the length of a hook, or needle, of the plurality of hooks (needles) measured along the longitudinal axis of the hook (needle). In addition, these flat or curved surfaces face the hooks.

Such features are present in the embodiment of the bar shown in FIG. 28, where the bar is a C-folded plate with the concavity facing the hooks and the ends of said C are flat surfaces lying in the same plane, and in the embodiment of FIG. 34, where a cylindrical bar is shown at which longitudinal ends a pin, extending in a direction transverse to the longitudinal axis X, is fixed.

The advantage is also obtained in case the bar has, or at least its longitudinal ends each have, a pair of corners 90i, 901 extending in a direction parallel to the longitudinal axis X, lie in the same plane parallel to the longitudinal axis and are spaced apart from each other in a direction transverse to the longitudinal axis X by an amount at least equal to 0.6 times the length of a hook, or a needle, of the plurality of hooks (needles) measured along the longitudinal axis of the hook (needle). In addition, such corners are facing the hooks.

Bars with these characteristics are shown in FIGS. 31 and 32, where the bars have a cross-section in the shape of a cross and a V cross-section respectively and are made as plates bent and/or welded with each other provided with two corners proximal to the hooks that lie in a same plane and are spaced apart along the direction transverse to the longitudinal axis.

FIG. 33 shows a solution that is hybrid to (and equivalent to) those above, wherein a corner and a flat surface lying in the same plane are present.

Hereinafter is a detailed description of the exact embodiments shown.

FIGS. 1 to 11 and 25 to 26 show two embodiments of the support element in which there is an appendage body for each hook 55, i.e. each needle, and the appendage body is aligned with the respective hook along a plane perpendicular to the longitudinal axis X, i.e. each appendage body is intersected by a plane perpendicular to the longitudinal axis X and intersecting the respective hook.

Each appendage body comprises a respective recess 85, which is for example aligned with the longitudinal axis K of the respective needle, and preferably the recess is oriented with the concavity facing the direction opposite to the bar. It is not excluded that in an alternative embodiment the slots may be replaced by slots arranged with a central axis perpendicular to a plane on which the longitudinal axis X lies, for example arranged with a central axis transverse (perpendicular) to the longitudinal axis K of the respective needle.

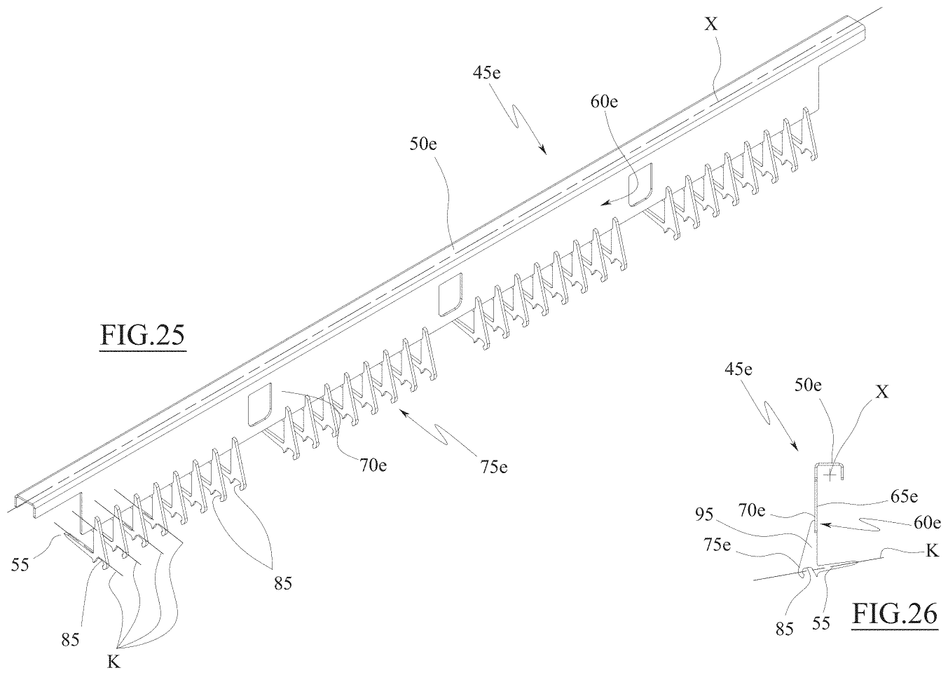

Always in such embodiments, the connection body 75a, 75e, or a portion of the connection body distal from the bar, is made as a plurality of bodies rigidly fixed to the bar, independently of each other, or to a portion of the connection body proximal to the bar. In addition, in the embodiment of FIGS. 25 and 26, the support element comprises a stiffening flange 95 that rigidly connects a portion of the grasping appendage 75e distal from the second face 70e to a central portion of the second face, interposed between a portion of the second face proximal to the bar and a portion of the second face proximal to the hooks.

Additionally, in this embodiment, the connection body, hooks and grasping bodies of the grasping appendage (e.g. also the stiffening flange) are made as a single body. It is not excluded that in an alternative embodiment, even just a needle and the respective grasping body may be made as a single body fixed to the connection body.

In the embodiment of FIGS. 1 to 1, the bar 50a is cylindrical in shape and in the embodiment of FIGS. 25 and 26, the bar 50e is made by bending a metal sheet and has the features mentioned above for the C-shaped bars.

FIGS. 16-18 show a support element characterised in that it comprises a grasping appendage 75c made as a seamless flat rectilinear plate (i.e. without recesses or slots) that, for example, extends longitudinally throughout the extension measured along the longitudinal axis X of the connection body 70c.

The plate is a body with a reduced thickness which has its smallest dimension in a direction perpendicular to the moving-away direction of the grasping appendage itself.

In addition, in this embodiment the hooks 55 are shaped like needles and the flat rectilinear plate is intersected, e.g. also divided into two symmetrical parts, by the lying plane of the longitudinal axes K throughout its extension in the moving-away direction. As mentioned above, this type of grasping appendage must be grasped with a gripper mechanism (not shown) that clamps the plate in a vice-like manner in a direction perpendicular to the moving-away direction.

Additionally, the bar is made by bending a metal sheet and has the features mentioned above for the C-shaped bars.

Preferably the entire support element is made by bending and cutting a single metal sheet, for example a single piece of metal sheet.

In the embodiment shown in FIGS. 12-15 and 19-21, the support element 45b is characterised in that it comprises a grasping appendage 75b made as a single body extending in a longitudinal direction throughout the length of the row needles or connection body, for example in the form of a flat plate at least in a portion of the grasping appendage proximal to the second face, and which is provided with a plurality of through-slots 80.

At least one of said through-slots 80 is present for each hook 55.

Preferably, two slots are provided for each hook 55, or at least for most hooks, which slots are placed laterally with respect to the hook, i.e. with respect to an imaginary projection of the hook onto the grasping appendage, said imaginary projection being made along a longitudinal axis of the hook itself. In the exact embodiment, the hooks are needles and the through-slots 80 are eccentric with respect to the longitudinal axis K of the respective needle. In practice the slots do not intersect the longitudinal axis K and preferably do not intersect and are placed immediately to the side of a projection of the hook on the grasping appendage, i.e. on the flat plate, said projection being made along the longitudinal axis k of the needle.

Two adjacent hooks have, for instance, a slot in common.

The plate is a body with a reduced thickness which has its smallest dimension in a direction perpendicular to the moving-away direction of the grasping appendage itself.

At least the portion of the grasping appendage proximal to the second face, which is made as a flat plate parallel to the longitudinal axis X, is intersected, for example also divided into two symmetrical parts, by the lying plane of the longitudinal axes K throughout its extension in the moving-away direction.

The grasping appendage also comprises a portion distal from the second face, placed at a greater distance from the second face than the through-slots, which is made as a flat plate inclined with respect to the flat plate of the portion proximal to the second face and parallel to the longitudinal axis X. This is done to make grasping even more stable.

Additionally, the bar is made by bending a metal sheet and has the features mentioned above for the C-shaped bars.

Preferably the entire support element is made by bending and cutting a single metal sheet, for example a single piece of metal sheet.

FIGS. 22-24 show an embodiment of the support element which differs from the embodiment shown in FIGS. 19-21 solely in that the hooks 55, for example shaped as needles, are divided into at least two rows which are at different distances from the bar 50d and for each of said rows a respective grasping appendage 75d is present. Such a plurality of grasping appendages is therefore placed at different distances from the bar.

In the embodiments shown, the hooks are all rectilinear needles and the fact that they are rectilinear is a functional advantage.

However, the basic inventive concept claimed in independent claim 1 is clearly independent of the fact that the hooks are rectilinear needles, in fact no reference is made to such longitudinal axes, therefore although no hooks other than rectilinear needles are shown, such as curved hooks, it is not excluded that the hooks may be curved and not rectilinear for all the described and claimed features which do not explicitly refer to the longitudinal axes of the rectilinear needles.

The different bars of the support elements are interchangeable with each other, although embodiments in which the bar (at least at its longitudinal ends) is not a single cylindrical body are preferable.

The support elements 45 with a grasping appendage 75 may be used in a process in which the portion of meat 10 is manually removed from the support element, i.e., the support element is removed from the portion of meat, manually, by an operator acting by hand by gripping the grasping appendage or by grasping it by means of a suitable tool (such as a gripper or a tool provided with a plurality of hooks adapted to be inserted into the through-slots/recesses). However, it is preferable to use an automated unloading apparatus such as the one described hereinafter.

When a portion of meat 10 is hooked to a respective support element 45, it means that the hooks 55, i.e. the needles, (all of them, unless there is a positioning error or excessive unevenness of the portion of meat) are inserted into the portion of meat 10 and pass through at least the first major face 20 of the portion of meat, preferably passing through it from the first major face 20 to the second major face 25. The first major face will be hereinafter referred to as the one which is definitely passed through by the hooks and which is proximal to the connection body 60. In particular, at least a portion of the first major face 60 contacts directly the first face 65 of the connection body.

The portion of meat is fixed/associated/hooked to the hooks 55 in an end portion thereof (peripheral portion), e.g. longitudinal, and under normal movement conditions, it hangs vertically from the hooks with most of its extension being below the support element 45 to which it is hooked (as shown in all the Figures).

In addition, the portions of meat 10, after the provided processing stations (smoking and/or cooling/freezing) are rigid, meaning that they have their own shape and cannot be easily deformed as occurs when the meat is unprocessed.

The invention makes available a method for extracting the portions of meat 10 from the respective support elements 45 to which the portion of meat is hooked.

The method firstly provides making available such a support element 45 to which at least one portion of meat is hooked and having at least the following characteristics:
the plurality of hooks 55 by means of which the portion of meat is hooked to the support element,
the bar 50 to which said hooks are rigidly connected by means of the connection body 60 comprising the first face 65, from which said hooks rise, and the second face 80 facing in the opposite direction to the first face, and
the grasping appendage 75 rising from the second face 70 in at least one direction away from the first face and the second face itself.

All this being prepared, the method comprises the steps of pulling (only) the grasping appendage 75 (only) in a predetermined extraction direction A while:
either holding (in a predetermined position) the portion of meat 10 e.g. by acting on its first major face of the hooked portion of meat,
or pushing the portion of meat 10, preferably by acting on it (only) with a pushing force on the first face 20 of the portion of meat (no other force acting anywhere else on the portion of meat), (only) in a predetermined pushing direction B opposite (and parallel to) the predetermined extraction direction A in which the grasping appendage 75 is pulled,

in both cases completely pulling the hooks off the portion of meat. That is, these steps (of pulling the grasping appendage while holding the portion of meat or pulling the grasping appendage while pushing the portion of meat in the opposite direction) are performed until the hooks are (all) completely pulled off the portion of meat.

This method allows the portions of meat 10 to be removed from the support elements 45 more efficiently than the known methods of the prior art, as it is not affected by errors in positioning the pork belly on the support element, leading to excessive overlapping of the portion of meat with the first face, since the extraction of the hooks from the portion of meat does not take place by pushing on the first face to move it away from the portion of meat, but rather by pulling the support element at the second face, so as to move the first face away from the portion of meat.

The predetermined extraction direction A is, for example, rectilinear.

The step of pulling the grasping appendage 75 in a predetermined extraction direction A is preferably performed by means of an automated gripping arrangement 130, therefore the method may comprise the step of arranging an automated gripping arrangement 130 configured to grasp and pull the grasping appendage 75 in the predetermined extraction direction A when the grasping appendage is in a predetermined position.

The step of pushing the portion of meat in the direction opposite to the extraction direction is preferably performed by means of an automated pushing arrangement, therefore the method may comprise the step of arranging an automated pushing arrangement configured to push the portion of meat in the predetermined pushing direction when the grasping appendage is grasped and pulled by the gripping arrangement.

In embodiments of an unloading apparatus implementing the steps of the method described herein and shown in the Figures, the method comprises the steps of pulling (only) the grasping appendage 75 in a predetermined extraction direction while holding (in a predetermined position) the portion of meat 10. However, it is clear to a person skilled in the art how to modify the gripping arrangement 130 to add the pushing arrangement 205 and obtain an unloading apparatus that implements the method of pulling the grasping appendage while pushing the portion of meat in the opposite direction.

The method may provide that the step of pulling the grasping appendage 75 in the extraction direction is preceded by the steps of:
preparing an abutment body 110 defining an abutment surface 115, e.g. flat,
bringing a section of a face of the portion of meat contacting the first face of the connection element, i.e. the first major face 20 of the portion of meat 10, into contact with the abutment surface 110 by acting on the bar and/or on the grasping appendage.

In all of the embodiments shown of the apparatus implementing the method, the method provides that the positioning of the first major face of the portion of meat in contact with the abutment surface is done by acting directly, i.e., by applying forces directly, on both the bar and the grasping appendage, i.e. only on both the bar and the grasping appendage. In practice, no action is taken on the connection body and in particular no force is applied directly to the first face of the connection body. However, it is not excluded that it may be sufficient to act on the bar alone to bring the first major face into contact with the abutment surface 115.

In the presence of the abutment surface, the predetermined extraction direction A in which the grasping appendage is pulled is away from the abutment surface 115.

In addition, the step of holding the portion of meat comprises the step of keeping the abutment surface 115 fixed with respect to the support element 45, for example fixed at a predetermined position in space, while performing the step of pulling the grasping appendage 75 in the predetermined extraction direction A, so as to extract the hooks from the portion of meat which is prevented from moving integrally with the support element thanks to the abutment surface.

The step of pushing the portion of meat (acting on its first major face) in a direction opposite to the predetermined extraction direction in which the grasping appendage is pulled, comprises instead the step of moving the abutment surface in a direction opposite to the extraction direction while performing the step of pulling the grasping appendage in the predetermined extraction direction, so as to extract the hooks from the portion of meat which is prevented from moving integrally with the support element thanks to the abutment surface. As mentioned earlier, this latter embodiment is not shown in the Figures, but it is a combination of the embodiments of the apparatus wherein the abutment surface is fixed, with the embodiment wherein, as will be explained hereinafter, the abutment surface is movable and the gripping arrangement merely holds, without pulling, the grasping appendage, within the reach of the technician in the field.

When the abutment body is present, the automated gripping arrangement 130 is preferably configured to grasp and pull the grasping appendage in the predetermined extraction direction A when the grasping appendage is at a predetermined distance from the abutment surface 115. In particular, such predetermined distance is before the portion of meat being moved touches the abutment surface with the first face.

The method may further provide that the step of bringing a section of the first major face 20 of the portion of meat into contact with the abutment surface by acting on the bar and/or on the grasping appendage is performed by means of an automated movement arrangement 120 configured to move the support element by acting on the bar and/or by means of an automated gripping arrangement 130 configured to grasp and pull the grasping appendage.

In the embodiments shown in the Figures, it is provided that this step takes place by means of both the movement arrangement and the gripping arrangement.

The step of pulling the grasping appendage to extract the needles from the portion of meat then begins after the first major face is in contact with the abutment surface.

Preferably, it is provided that the abutment appendage is grasped by the gripping arrangement 130, before the first major face of the portion of meat comes (is brought) into contact with the abutment surface.

The method may provide that the step of bringing a section of the first major face of the portion of meat into contact with the abutment surface by acting on the bar and/or on the grasping appendage is preceded by the step of moving, for example by means of the automated movement arrangement, the support element 45, by acting (only) on its bar 50, in a predetermined movement direction along a predefined trajectory C (open, i.e. not closed in a loop) transverse to a lying plane of the abutment surface and placed at a predetermined distance from the abutment surface, so that the portion of meat moved along such trajectory arrives at a (central) section thereof to contact the abutment surface with its face in contact with the first face of the connection element. In particular, the trajectory comprises a first point P1, upstream of the abutment surface 115 with respect to the predetermined movement direction, and a second point P2 downstream of the abutment surface with respect to the movement direction. The trajectory also comprises a third point P3, which corresponds to the point wherein the first major face of the portion of meat is in contact with the abutment surface. That is, when the bar of the connection element reaches the third point, the first major face of the portion of meat is in contact with the abutment surface 115.

The movement arrangement is configured to move the support element along such trajectory C in the predetermined direction, at least from the first to the second point.

In addition, during the movement along said trajectory, the second face 70 of the connection element 60 is kept facing the second point, i.e., it is kept facing a plane parallel to the lying plane of the abutment surface 115 and intersecting the second point P2. In other words, the movement arrangement is configured to move the support element along such trajectory while keeping the second face of the support element facing a plane parallel to the lying plane of the abutment surface and intersecting the second point.

The predefined trajectory lies in a plane perpendicular to the lying plane and the longitudinal axis X of the bar of the support element being moved.

The predefined trajectory is, for example, rectilinear or made up of a plurality of consecutive rectilinear sections.

In addition, the predetermined extraction direction along which the pulling appendage is pulled is, for example, the direction approaching the second point of the trajectory, i.e. the direction approaching the plane parallel to the lying plane of the abutment surface and intersecting the second point.

In case the support elements comprise hooks in the form of needles, as in the Figures shown, the method may provide that the extraction direction A is parallel to the longitudinal axes K, preferably that it is also aligned therewith, or that it lies in a plane in which the longitudinal axes K lie. In this circumstance, reference is made to the longitudinal axes as they are arranged while the support elements are moved from the first point towards the second point, and in detail as they are arranged in proximity to the abutment surface, for example at the third point P3.

In particular, the extraction direction is parallel to the longitudinal axes K, preferably also aligned therewith, when the grasping appendage is grasped. This specification is particularly important in case the bar 50 has cylindrical longitudinal ends and can therefore rotate more easily as the thickness of the portion of meat varies.

In addition, in case the grasping appendage comprises recesses or through-slots, the gripping arrangement comprises a gripping body configured to grasp all the through-slots or recesses present in the grasping appendage.

The abutment surface may lie on a vertical or horizontal plane.

In case the abutment surface lies in a vertical plane, the predetermined extraction direction is substantially horizontal, whereas in case the abutment surface lies in a horizontal plane, the predetermined extraction direction is substantially vertical.

The invention also makes available another method that solves the same technical problem of the prior art of the above-described method.

This other method, or second method, to distinguish it from the first previously described method, firstly provides to make available such a support element 45 to which at least a portion of meat is hooked and having at least the following characteristics:
the plurality of hooks 55 by means of which the portion of meat is hooked to the support element,
the bar 50 to which said hooks are rigidly connected by means of the connection body 60 comprising the first face 65, from which said hooks rise, and the second face 80 facing in the opposite direction to the first face, and
the grasping appendage 75 rising from the second face 70 in at least one direction away from the first face and the second face itself.

Having prepared this, the second method comprises the steps of holding (only) the grasping appendage (in a predetermined position) while pushing the portion of meat 10, for example by acting on its first major face 20 of the hooked portion of meat, preferably by acting only with a pushing force on the first face of the portion of meat (no other force acting anywhere else on the portion of meat), (only) in a predetermined pushing direction B moving away from the hooks 55 of the support element, (e.g. also from the first face 65 and from the grasping appendage 75), completely pulling the hooks off the portion of meat, i.e. such steps are performed until the hooks are (all) completely pulled off from the portion of meat. Such moving-away direction, for example, faces the same direction as the first face of the support element.

The step of holding the grasping appendage in a predetermined direction is preferably performed by means of an automated grasping arrangement 130, therefore the method may comprise the step of arranging an automated gripping arrangement 130 configured to grasp and hold the grasping appendage in a predetermined position when the grasping appendage is in a predetermined position.

The step of pushing the portion of meat in the predetermined pushing direction B is preferably performed by means of an automated pushing arrangement 205, therefore the method may provide the step of arranging an automated pushing arrangement 205 configured to push the portion of meat in the predetermined direction moving away when the grasping appendage is held by the gripping arrangement.

The method may provide that the step of pushing the portion of meat in the predetermined moving-away direction, is preceded by the steps of:
preparing an abutment body 110 defining an abutment surface 115, e.g. flat,
bringing a section of a face of the portion of meat contacting the first face of the connection member, i.e. the first major face 20 of the portion of meat, into contact with the abutment surface 155 by acting on the bar 50 and/or the abutment appendage 75 of the support member.

The abutment surface may lie on a vertical plane or on a horizontal plane, only the version with a vertical abutment surface is shown in the figures of the apparatus implementing this method.

In the embodiment shown of the unloading apparatus implementing the method, the positioning of the first major face of the portion of meat contacting the abutment surface can take place by acting directly, i.e. applying forces directly, only on the bar. In practice, no action is taken on the connection body or on the grasping appendage to perform such step.

In case the abutment surface 115 is present, the step of pushing the portion of meat is performed by moving the abutment surface 155 in the predetermined pushing direction B.

In addition, the step of holding the grasping appendage 75 comprises the step of keeping said grasping appendage fixed in a predetermined position in space while performing the step of pushing the portion of meat 10, for example by moving the abutment surface, in the predetermined pushing direction B, so as to extract the portion of meat from the hooks, which are prevented from moving integrally with the portion of meat because the grasping appendage 75 is kept in the predetermined position.

When the abutment body is present, the automated pushing arrangement 205 may be configured to push the portion of meat in the predetermined pushing direction B when the grasping appendage 75 is at a predetermined distance from the abutment surface. In particular, such predetermined distance is before the portion of meat being moved touches the abutment surface with the first face.

Alternatively, the step of moving the abutment surface in the pushing direction B to extract the hooks 55 from the portion of meat may begin after the first major face is in contact with the abutment surface.

In any case, the abutment surface is moved to extract the portion of meat only after the grasping appendage has been grasped.

It may be provided to grasp the grasping appendage by means of the gripping arrangement before the first major face of the portion of meat comes (is brought) into contact with the abutment surface.

The method may further provide that the step of bringing a section of the first major face 20 of the portion of meat into contact with the abutment surface 115 by acting on the bar 50 is performed by means of an automated movement arrangement 120 configured to move the support element by acting on the bar and/or by means of the automated gripping arrangement 130 configured to grasp and pull the grasping appendage.

The method may comprise that the step of bringing a section of the first major face of the portion of meat into contact with the abutment surface by acting on the bar and/or on the grasping appendage, is preceded by the step of moving, for example by means of the automated movement arrangement 120 the support element 45, by acting (only) on its bar 50, in a predetermined movement direction along a predefined trajectory C, the characteristics of which will not be repeated, since they are the same as the predefined trajectory C of the first method.

The predetermined pushing direction in which the portion of meat is pushed is for example in the direction approaching the first point of the trajectory, i.e. in the direction approaching a plane parallel to the lying plane of the abutment surface and intersecting the first point.

In case the support elements comprise hooks 55 in the form of needles, as in the Figures shown, the method may provide that the predetermined pushing direction is parallel to the longitudinal axes K, preferably also aligned therewith, or that it lies in a plane on which the longitudinal axes K lie.

In this circumstance reference is made to the longitudinal axes as they are arranged while the support elements are moved from the first point towards the second point, and in detail as they are arranged in proximity to the abutment surface, for example at the third point P3.

In particular, the pushing direction is parallel to the longitudinal axes K, preferably also aligned therewith, when the grasping appendage is grasped.

In the embodiment shown, such pushing direction is inclined with respect to a vertical plane.

In addition, in case the grasping appendage comprises recesses or through-slots, the gripping arrangement includes a gripping body 135 configured to grip all the through-slots or recesses in the grasping appendage.

As mentioned above, such methods are implemented in automated unloading apparatuses 40 configured to unhook/pull one or more portions of meat off a respective support element to which they are hooked.

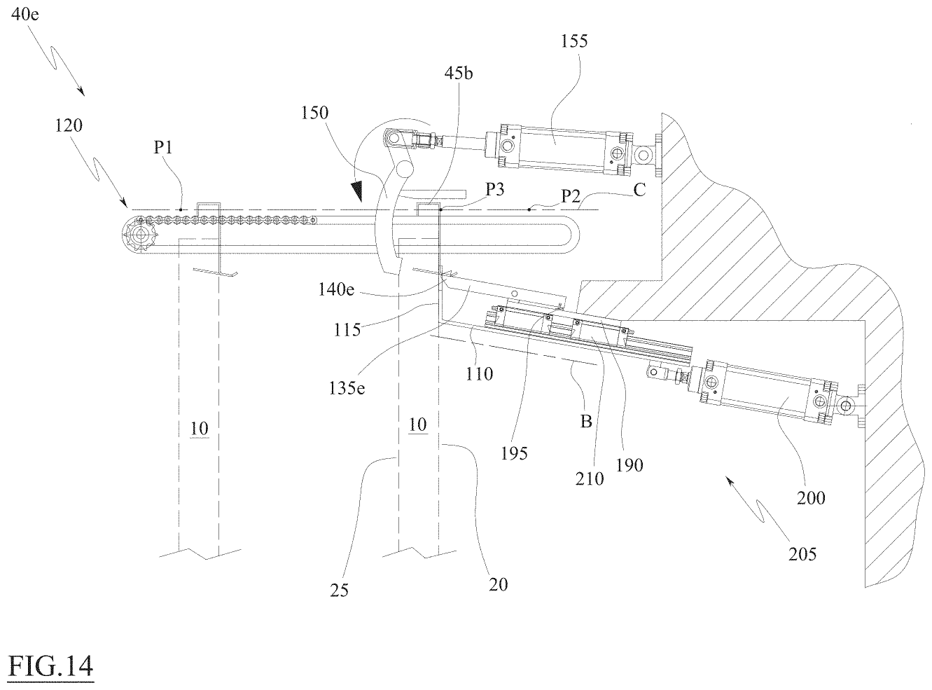

The first method is implemented by the unloading apparatuses 40a, 40b, 40c, 40d of FIGS. 1-13 and the second method by the unloading apparatus 40e of FIGS. 14-15 respectively.

Apparatuses implementing the first method will be firstly described hereinafter. In all the unloading apparatuses an abutment body 110 is present, which is adapted to contact, i.e. be contacted, by the portion of meat 10, for example by the first major face 20 of the portion of meat. In particular, the abutment body 110 comprises an abutment surface 115 adapted to be contacted by the portion of meat 10, in particular by the first major face 20 of the portion of meat.

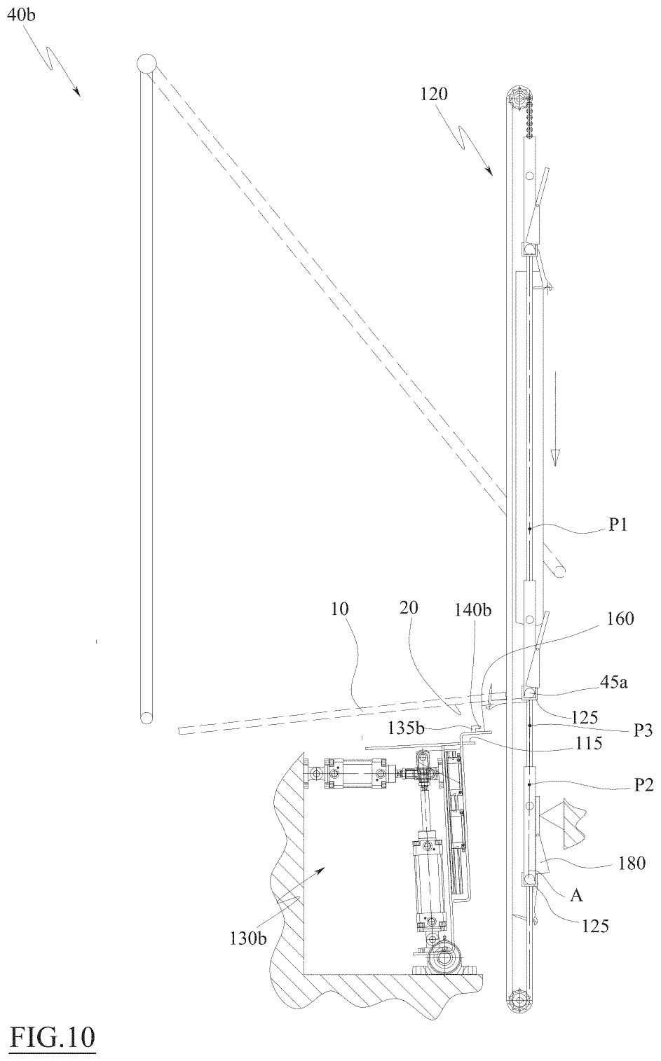

In the embodiments shown, the abutment surface 115 is flat, and may lie either in a vertical plane, as in FIGS. 1-9 and 11-13, or in a horizontal plane, as in FIG. 10.

In case the grasping appendage is provided with a plurality of grasping bodies as in embodiments 75a and 75e, the abutment surface 115 comprises a plurality of protrusions that extend along the lying plane of the abutment surface 115 from an edge thereof and are configured and sized to fit into the gaps present between the grasping bodies.

In the case of the embodiments of the unloading apparatus 40a, 40b, 40c, 40d implementing the first method, the abutment body 110 is fixed with respect to the support element 45, or rather is at least fixed with respect to a gripping body, as will be described hereinafter. In particular, in the embodiments of the unloading apparatus 40a and 40d the abutment body 110 is rigidly fixed to a frame of the support apparatus. While in the embodiments 40b and 40c, the abutment body 110 is hinged to the frame of the support apparatus and the gripping body is movable relative to the abutment body, for example it is associated with the abutment body by a rectilinear slide.

In all the embodiments of the apparatus 40a, 40b, 40c, 40d, the unloading apparatus further comprises a movement arrangement 120 of the support elements, which is of an automated type and is configured to move the at least one support element in a predetermined direction along a predefined trajectory C.

In particular, the bar of the support element is moved along a trajectory that is perpendicular to the longitudinal axis X of the bar itself.

During the movement along such predefined trajectory C, the support element is held with its longitudinal axis X lying on a horizontal plane and is moved perpendicular to its longitudinal axis X.

Said predefined trajectory is transverse, preferably perpendicular, to a lying plane of the abutment surface and is placed at a predetermined distance from the abutment surface 115 such that the portion of meat with which the support element is associated and moved along such trajectory comes into contact with the abutment surface. Such trajectory is therefore eccentric with respect to the abutment surface. In addition, the distance is preferably such that at least a portion of the first major face 20 of the portion of meat protruding from the support element and proximal to the hooks of the support element comes into contact with the abutment surface.

The predefined trajectory lies in a plane perpendicular to the lying plane and the longitudinal axis X of the bar of the support element being moved.

In addition, the trajectory is preferably oriented in such a way that at a (single) point of the trajectory the longitudinal axis X of the support element lies (entirely) in the lying plane of the abutment surface.

Therefore, in case the abutment body lies in a vertical plane, the predefined trajectory lies in a vertical plane that is transverse, e.g. perpendicular, to the lying plane of the abutment surface and extends horizontally.

In case the abutment body lies in a horizontal plane, the predefined trajectory lies in a vertical plane that is transverse, e.g. perpendicular, to the lying plane of the abutment surface and is substantially vertical.

The predefined trajectory is, for example, rectilinear or made up of a plurality of consecutive rectilinear sections lying in the same vertical plane.

The trajectory comprises a first point P1, upstream of the abutment surface with respect to the predetermined movement direction, and a second point P2 downstream of the abutment surface with respect to the movement direction.

Thus, in case the abutment body lies in a vertical plane, the first point is in front of the abutment surface 115, i.e. the abutment surface faces the first point (or faces a plane passing through the first point and parallel to the plane of the abutment surface), and the second point is behind the abutment surface 115, i.e. the abutment surface faces the direction opposite to the second point (or faces the direction opposite to a plane passing through the second point and parallel to the lying plane of the abutment surface).

The second point, i.e. the plane passing through the second point and parallel to the abutment surface, is at a minimum distance from the lying plane of the abutment surface greater than the length of the hooks, preferably greater than the maximum dimension of the support element measured along a direction perpendicular to the abutment surface.

When, by contrast, the abutment body lies in a horizontal plane, the first point is at a greater vertical quota than a vertical quota in the lying plane of the abutment surface, and the second point is at a lower vertical quota than a vertical quota in the lying plane of the abutment surface.

In addition, during the movement along said trajectory, the second face 70 of the connection element is kept facing the second point P2, i.e. it is kept facing a plane parallel to the lying plane of the abutment surface and intersecting the second point. In other words, the movement arrangement is configured to move the support element along such trajectory while keeping the second face 70 of the support element facing a plane parallel to the plane of the abutment surface and intersecting the second point.

The trajectory also comprises a third point P3, which corresponds to the point wherein the first major face of the portion of meat is in contact with the abutment surface. That is, when the bar of the connection element reaches the third point, the first major face of the portion of meat is in contact with the abutment surface

The movement arrangement is configured to move the support element along such trajectory C in the predetermined direction, at least from the first to the second point.

The movement arrangement may be configured to move the support element, now without the portion of hooked meat, even beyond the second point in order to deliver it to an apparatus configured to re-introduce the support elements released from the portions of meat into the plant cycle.

The movement arrangement may comprise, for example, two flexible inextensible members each closed in a loop around two or more pulleys or toothed wheels.

Said flexible members lie in vertical planes that are parallel to each other and configured so that each one makes available a flat transport surface onto which the bar of the support element rests, i.e. a respective longitudinal end of the bar rests on each transport surface.

The transport surface, i.e. the transport surfaces lie on a substantially horizontal (+/−20°) plane, preferably horizontal.

In case the abutment surface lies in a vertical plane, throughout the trajectory C from the first to the second point, the flexible members define, i.e. an upper portion thereof, one or more substantially horizontal support surfaces.

In case the abutment surface lies in a horizontal plane, each flexible member is connected to a support element 125 comprising a U-shaped body provided with a back wall on which a respective longitudinal end of the bar upperly rests and which defines the flat transport surface of the bar.

For example, the flexible member, i.e. each flexible member, is a chain (of the Galle type, i.e. for example with holed rollers). However, in an embodiment not illustrated herein the flexible member may be a belt or a cable.

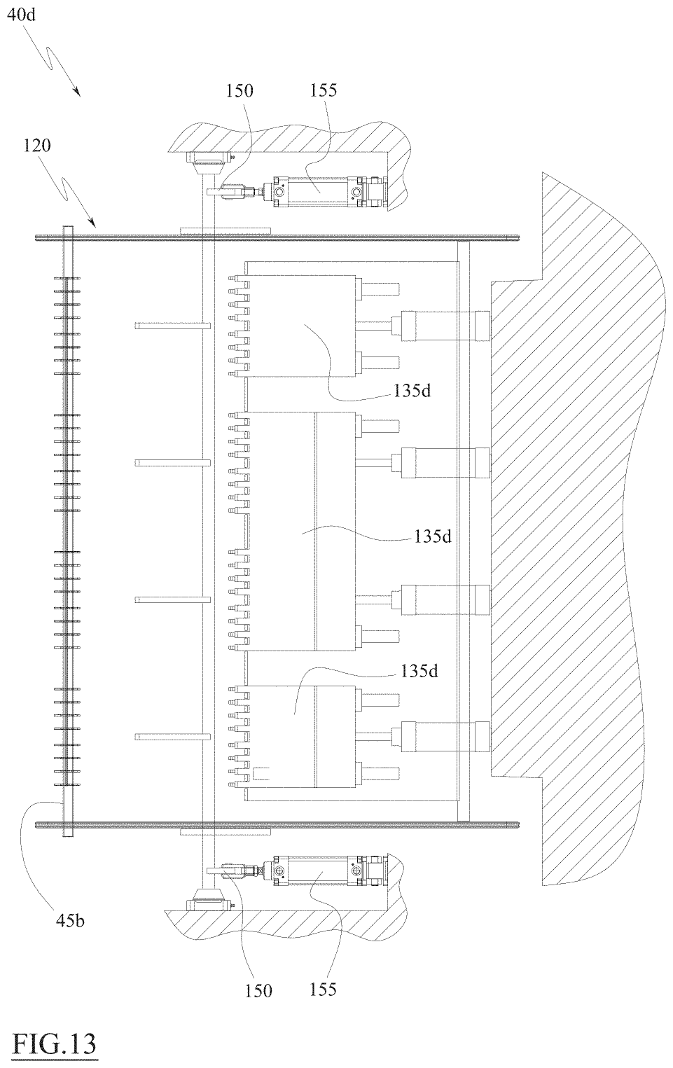

The unloading apparatus comprises a (single) gripping arrangement 130a, 130b, 130c, 130d positioned in proximity to the abutment surface and provided with a (single) gripping body 135a, 135b, 135d configured to (only) grasp the grasping appendage. As can be seen in the view from above of FIG. 13, there may be a plurality of gripping bodies independent of each other (i.e. driven with independent drives) and configured to grasp a single support element. Although this possibility is shown only for the embodiment 40d of the unloading apparatus, it is applicable to all other embodiments of unloading apparatus shown (even those implementing the second method, in which case a plurality of abutment bodies will be present).

For example, the gripping body is placed between the third point P3 and the second point P2, i.e. between planes parallel to the lying plane of the abutment surface of the reference surface 115 and passing through such points.

The gripping arrangement comprises a drive of the gripping body 135a, 135b, 135d configured to move (cyclically or selectively), the gripping body into a grasping position, wherein the gripping body grasps the grasping portion, and to subsequently pull the gripping body in a predetermined extraction direction A that is away from the abutment surface 115 (and approaching the second point P2, i.e., a plane parallel to the abutment surface and intersecting the trajectory at the second point), extracting the hooks from the portion of meat that is held in contact with the abutment surface. The extraction direction is therefore in the same direction in which the support element is moved from the first to the second point.

In particular, the drive is configured to move the gripping body between a first position, wherein the gripping body is proximal to the abutment surface and can grasp the abutment appendage, and a second position wherein it is distal from the abutment surface, and wherein the gripping body is moved from the first position to the second position along the extraction direction A, approaching the second point. In particular, the gripping body of the embodiment can also be driven in a third position that follows the second one and precedes the first one, which can be defined as the disengagement position, in which the gripping body does not act on the grasping appendage (unless the gripping body is provided with an abutment body, as will become clearer hereinafter). In addition, grasping takes place in the movement from the third position to the first position.

The movement arrangement and the gripping arrangement are synchronised in such a way that, while moving from the first point to the second point, the support element is at a predetermined distance from the third point (distance which can be zero or greater than zero), the drive moves the gripping body to the first position and then from the first position to the second position.

In the gripping arrangement 130a, the drive of the gripping body comprises a first and a second linear actuators which are both provided with a portion connected to the frame of the apparatus and a portion which is movable with respect to the fixed portion along a rectilinear movement axis lying on a vertical plane.

In particular, the fixed portion of the first actuator is integral, without residual degrees of freedom, to the frame, and the fixed portion of the second actuator is hinged to the frame according to a horizontal hinge axis.

The movable portions are hinged to the gripping body 135a according to horizontal hinge axes and eccentric to each other (the gripping body is connected only to such actuators). In addition, the movement axis of the first linear actuator is vertical, and the actuation axis of the second linear actuator is transverse to the movement axis of the first actuator.

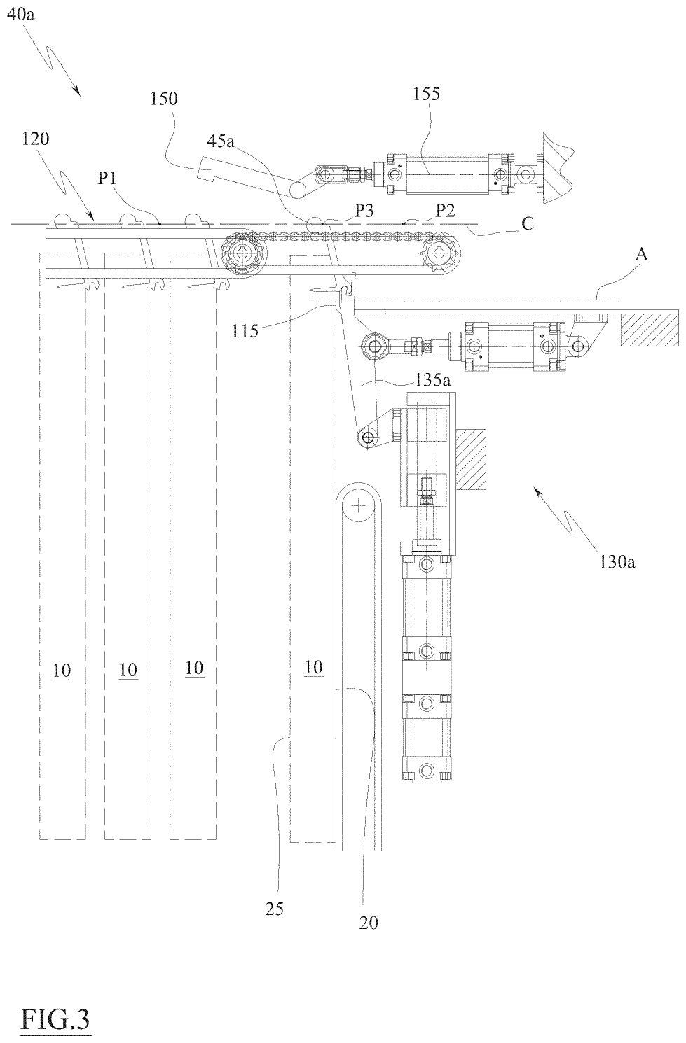

By means of the first actuator, it is possible to vertically move the gripping body to bring it to the first position (see FIG. 3), then, by activating the second actuator, the movement of the gripping body between the first position and the second position along the extraction direction A takes place. In practice, by vertically moving the gripping body with the first actuator, it is possible to orientate the actuation axis of the second actuator so as to make it parallel or coincident with the extraction direction A. Still in other words, when the movable portion of the second actuator and the movable portion of the second actuator are at a predetermined distance from the fixed portion such that the first position is realised, the drive axis of the second actuator is parallel to or coincident with the extraction direction A (e.g. parallel) and the movable portion of the second actuator is moved towards the fixed portion, while maintaining the movable portion of the second actuator at the distance previously reached by its fixed portion at the first position of the gripping body, in order to perform the movement between the first position and the second position along the extraction direction A. In this way, the support element is recalibrated with respect to the abutment body, which remains fixed with respect to the support element. All hinge axes described for this embodiment of gripping arrangement lie in a plane perpendicular to the predetermined extraction direction A.

In the gripping arrangement 130b, wherein the abutment surface 115 is horizontal, the drive of the gripping body comprises a first and a second linear actuator, both of which are provided with a portion connected to the frame of the apparatus itself and a portion which is movable relative to the fixed portion along a rectilinear movement axis lying on a vertical plane.

In particular, the fixed portion of the first actuator is hinged to the frame according to a horizontal hinge axis, and the fixed portion of the second actuator is hinged to the frame according to a horizontal hinge axis eccentric with respect to the hinge axis of the fixed portion of the first actuator.

The movable portion of the first actuator is hinged, according to a horizontal hinge axis, to a rail integral, without residual degrees of freedom, to the fixed portion of the second actuator, and the movable portion of the second actuator is hinged to a slide slidingly associated with the rail according to a sliding axis. The gripping body 135b is integral, without residual degrees of freedom, to the slide and the abutment body 110 is integral without residual degrees of freedom to the rail. In addition, the movement axis of the first linear actuator is arranged substantially horizontally, and the movement axis of the second linear actuator is transverse to the movement axis of the first actuator, i.e. substantially vertical.

By the first actuator it is possible to horizontally move the gripping body to bring it to the first position, and then by driving the second actuator, the movement of the gripping body between the first position and the second position along the extraction direction A, which in this case is vertical, takes place. In practice, by horizontally moving the gripping body with the first actuator, it is possible to orientate the actuation axis of the second actuator to bring it parallel to or coincident with the extraction direction A. Still in other words, when the movable portion of the second actuator and the movable portion of the second actuator are at a predetermined distance from the fixed portion such that the first position is realised, the drive axis of the second actuator is parallel to or coincident with the extraction direction A (e.g. parallel) and the movable portion of the second actuator is moved towards the fixed portion, while maintaining the movable portion of the second actuator at the distance previously reached by its fixed portion at the first position of the gripping body, in order to perform the movement between the first position and the second position along the extraction direction A. In this way, the support element is recalibrated with respect to the abutment body, which remains fixed with respect to the support element. All hinge axes described for this embodiment of gripping arrangement lie in a plane perpendicular to the predetermined extraction direction A.

The gripping arrangement 130b is coupled with a mechanism configured to carry the portions of meat, which are moved hanging from the support elements and are thus arranged substantially vertically, so that the first major face lies in a plane transverse to a vertical plane, for example lies in a substantially horizontal plane. In the embodiment, it is shown a mechanism which is known in the art under the name of a swing, and which will therefore not be described in detail. Alternatively, it is possible to use a pad moved by a linear actuator along a horizontal axis.

The gripping arrangement of the embodiment 130c is substantially that of the embodiment 130b configured to work with a vertical abutment surface, and differs from the gripping arrangement 130a in particular because in the embodiment 130a the abutment surface is fixed to a frame to which the actuators of the abutment body 130a are connected, whereas in the embodiment 130c, as in 130b, the abutment body is always fixed with respect to the gripping body, but is movable with respect to the frame to which the actuators are associated.

For the operation of the apparatus defined hitherto, i.e. of the different embodiments of apparatuses defined hitherto, not all the characteristics of the support elements discussed above are required, but it is sufficient that the support element comprises:
a plurality of hooks capable of penetrating the portion of meat,
a bar to which said hooks are rigidly connected by means of a connection body comprising a first face, from which said needles rise, and a second face facing in the opposite direction to the first face, and
a grasping appendage rising from the second face in at least a direction away from the first face and from the second face.

For example, the drive of the gripping arrangement 130a is used in particular in case the grasping appendage comprises recesses 85, as the vertical movement of the first actuator allows to simply insert one hook 140a of the gripping body into the recess to perform the grasping, or a plurality of hooks 140a of the gripping body into the respective recesses of the grasping portion in order to perform the grasping. Such hooks 140a are facing upwards being the recesses facing downwards.

The unloading apparatus 40a actually has support elements according to the embodiment 45a and the gripping body comprises a plurality of hooks or pins adapted to be inserted into said recesses. However, the described drive may also be used, with slight modifications, in all of the other embodiments of the support elements, comprising the one that requires grippers to grasp the grasping portion.

The gripping body of the embodiment 135b also comprises a hook 140b, i.e. a plurality of hooks 140b shaped as in the embodiment 135a.

The gripping arrangement 130d can only be used in case the support element comprises the grasping appendage provided with through-slots or recesses. In the embodiment shown, such gripping assembly cooperates with the support element of the embodiment referred to as 45b.

In such a case, the gripping body comprises a hook-shaped portion 140d facing upwards made at a longitudinal end of the gripping body itself, at an opposite longitudinal end, it is connected to a slide 144 by means of an elastic element 145, which generates a force approaching the longitudinal end to which it is connected to the slide and in a central portion comprised between the two ends, it is hinged to said slide according to a horizontal hinge axis lying on a plane perpendicular to the predetermined extraction direction A.

In particular, the gripping body comprises a plurality of hook-shaped portions 140d.

The gripping arrangement then comprises a rail 146, which is integral, without any residual degrees of freedom, to the frame, to which the slide is slidingly associated along a sliding axis parallel to the extraction direction.

The slide is controlled, in its sliding movement relative to the rail, by a single linear actuator, which is configured to move the gripping body between the first and second position only.

The grasping of the grasping appendage takes place by moving the support element towards the second point P2 while the grasping body is already in the first position, stationary.

By pushing the support element towards the second point, by means of the movement arrangement and/or also with the aid of a pushing body, as will be described hereinafter, the grasping appendage contacts the end of the gripping body in which the hooks are present, making it rotate with respect to the hinge axis with the slide contrasting the force exerted by the elastic element. Due to such a rotation, the hooks are brought underneath the grasping appendage and continuing the movement of the support element towards the second point, when the hooks are aligned with the through-slots, thanks to the force of the elastic element working to push the hooks upwards, said hooks are automatically inserted into the through-slots, grasping the grasping appendage.

Subsequently the linear drive moves the slide bringing the gripping body from the first position to the second position. The portion of meat, being blocked by the abutment surface, cannot continue with the support element and consequently the hooks are pulled off from the portion of meat.

Irrespective of whether the apparatus implements the first or the second method, and irrespective of the characteristics of the support element, the apparatus may further comprise a pushing body 150 placed in proximity to the abutment surface and selectively movable at least in a position where it prevents the support element from moving towards the first point of the trajectory by acting on the bar, or on the ends of the bar.

In particular, in the embodiments wherein the abutment surface lies in a vertical plane, irrespective of which method implements the apparatus, whose pushing body can also be driven, when it is in the position wherein it prevents the support element from moving towards the first point of the trajectory, towards the second point of the trajectory so as to push the support element towards said second point.

In particular, the pushing body is movable between a first position, in which it is at a higher quota than the predetermined trajectory and does not interfere with the support element, and a second position in which it intersects the predetermined trajectory and contacts the support element. When moving from the first position to the second position, the pushing body pushes the bar towards the second point of the trajectory.

In the embodiment shown, the pushing body is hinged to a frame of the unloading apparatus, at a point at a vertical quota greater than the movement arrangement, i.e. the flexible components, with respect to a horizontal hinge axis and lying on a lying plane parallel to the lying plane of the abutment surface. In addition, said pushing body is moved by a linear actuator 155 provided with a fixed portion integral with the frame of the unloading apparatus and a movable portion, which is movable with respect to the fixed portion along a movement axis and to which an end of the pushing body, eccentric to the hinge axis with respect to which the pushing body is connected to the frame, is hinged.

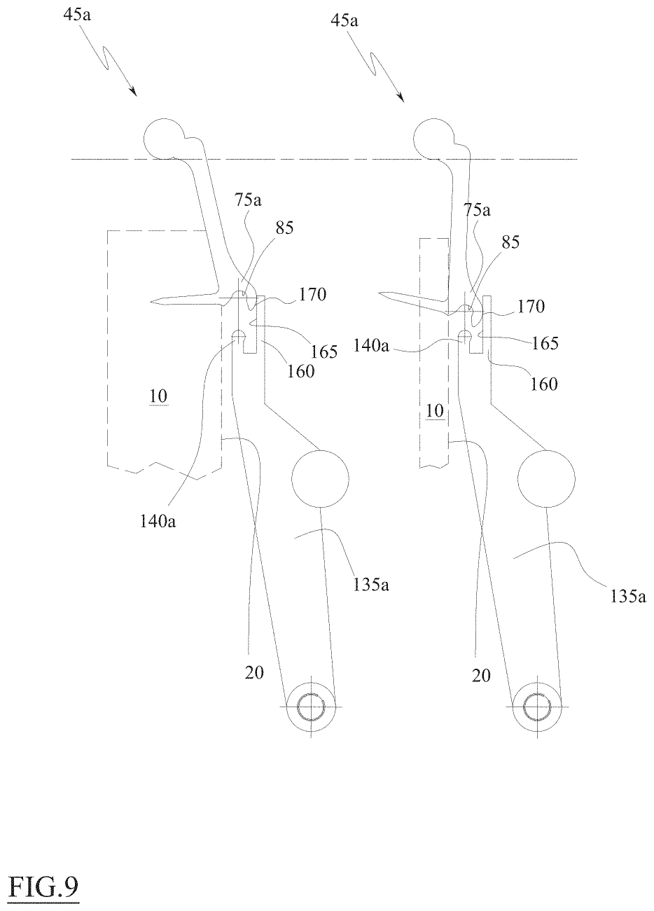

In the embodiments of the gripping body 135a, 135b, the gripping body also comprises an abutment body 160, see FIG. 8 and FIG. 9.

This abutment body has an abutment surface 165, which is flat, lying in a plane parallel to the longitudinal axis X, and facing both towards the hook of the gripping body and towards a plane perpendicular to the abutment surface and passing through the first point P1.

Substantially, the abutment surface is located behind the hook with respect to the direction along which the support elements move from the first point to the second point.

The abutment surface lies for example in a plane that is also parallel to a longitudinal axis of the hook.

The hook preferably has a free circular end that is adapted to fit into the recess.

Furthermore, in such a case, as in the embodiment 45a, the grasping appendage comprises, at its free end, a curvilinear surface 170 (see FIG. 9) with a central axis positioned at the centre of the recess and parallel to the longitudinal axis X.

In such a case, the minimum distance of the abutment surface 165 from a curved axis of the free end of the hook 140a (axis parallel to the longitudinal axis X) is equal to the distance of the curvilinear surface 170 of the free end of the grasping appendage from its central axis. Thereby, even if the bar rotates relative to the support surface due to portions of meat having a thickness beyond a predetermined range, when the curvilinear surface touches the abutment surface it is always possible to activate the hook in a direction of insertion into the groove.

In such a case, the pushing body and its actuator are configured so as to push the grasping appendage of the support element against the abutment body (this may take place when the gripping body is in the third position). It is thereby made sure that the grasping appendage is at the predetermined distance before activating the gripping body in the first position.

The apparatus may for instance provide a sensor arrangement (not shown) configured to monitor a parameter indicative of the presence of the grasping appendage in contact with the abutment body, which sensor arrangement is operatively connected to the electronic control and command unit, which is configured to activate the gripping body from the third position to the first position when it detects, through the sensor arrangement, the presence of the grasping appendage in contact with the abutment body.

In case the abutment surface lies on a horizontal plane, the pushing body is configured to hold the bar, or its ends, within the respective support elements 125, in particular in contact with the bottom surface.

In the embodiment shown, the pushing body is made as a rod-shaped body 180 and hinged to the support element.

Such characteristics of the abutment surface and the pushing body, although shown only in apparatuses implementing the first method, may also be applied to the apparatus of the second method in case support elements such as those shown in the embodiments 45a and 45e are used in that method.

Another feature that takes advantage of the peculiarities of the support elements may be the fact that the extraction direction A is parallel to the moving-away direction along which the grasping portion extends. In other words, the extraction direction is parallel to the longitudinal K axes of the needles. In particular, such parallelism refers to when the grasping appendage is grasped by the gripping body.

As previously said, the second method for extracting the hooks, i.e. the needles is implemented by the unloading apparatus 40e of FIGS. 14-15. In such apparatus the support element is held in place by grasping it by the grasping appendage while the abutment body, instead of being fixed, is moved to push the portion of meat away from the support element.

Said unloading apparatus comprises an abutment body 110, which is adapted to contact, i.e. being contacted by, the portion of meat 10, for example by the first major face 20 of the portion of meat. In particular, the abutment body 110 comprises an abutment surface 115 adapted to be contacted by the portion of meat 10, in particular by the first major face 20 of the portion of meat.

In the embodiments shown, the abutment surface 115 is flat, and may lie on a vertical plane, but it is not excluded that in an alternative embodiment it may lie on a horizontal plane.

Still in a case, not shown, wherein the grasping appendage was provided with a plurality of grasping bodies as in embodiments 75a and 75e, the abutment surface 115 would comprise a plurality of protrusions that extend along the lying plane of the abutment surface 115 itself starting from an edge thereof and are configured and sized to fit into the gaps present between the grasping bodies.

The unloading apparatus 40e further comprises a movement arrangement 120 shaped like that of the other embodiments of the unloading apparatus wherein the abutment surface is vertical

The unloading apparatus comprises a (single) gripping arrangement 130e positioned in proximity to the abutment surface and provided with a (single) gripping body 135e configured to (only) grasp the abutting appendage. Obviously, there may be a plurality of gripping bodies independent of each other (i.e. actuated with independent drives) and configured to grasp a single support element.

In this apparatus, the gripping arrangement does not comprise a drive of the gripping body 135e, because the gripping body is of the type described in the embodiment 135d, so it does not have to be brought into the third position and then into the first position to perform the grasping, and also because in this embodiment the extraction of the hooks takes place by pushing the portion of meat by moving the abutment surface.

However, it is not excluded that in an alternative embodiment the gripping arrangement may, for example, be like that of embodiment 130a. In such a case, the gripping arrangement would comprise an actuator configured to move (cyclically or selectively), the gripping body between a first position, i.e., a disengagement position, in which the gripping body does not act on the grasping appendage, and a second position, in which the gripping body is proximal to the abutment surface and can grasp the grasping appendage while passing from the first to the second position. As it is not required to pull the grasping appendage, no drive position of the gripping body is provided in which it moves away from the first position along an extraction direction.

Going back to the embodiment 40e shown, in this case the abutment body is associated with the frame of the unloading apparatus. In particular, the abutment body is hinged according to a hinge axis horizontal and parallel to the axis X longitudinal to the frame. Still in more detail in this case, the gripping body comprises a hook-shaped portion 140e facing upwards made at a longitudinal end of the gripping body itself, it is connected, at an opposite longitudinal end, to a rail 190 rigidly integral, without residual degrees of freedom, to the frame of the unloading apparatus by means of an elastic element 195, which generates a force approaching the longitudinal end to which it is connected to the slide, and, in a central portion between the two ends, is hinged to said rail according to said horizontal hinge axis.

In particular, the gripping body comprises a plurality of hook-shaped portions 140e.

The abutment body 110 is movable at least with respect to the gripper body, in particular it is movable in space with respect to the frame to which the gripping arrangement is associated.

For example, the unloading apparatus 40e comprises a (linear) actuator 200 that moves the abutment surface between a first position and a second position, wherein in said second position the abutment surface is closer to the first point of the trajectory than in the first position and further away from the gripping body.

In particular, between the first and second positions, the abutment body moves in a predetermined pushing direction B, e.g. rectilinear.

The unloading apparatus therefore comprises a pushing arrangement 205 comprising said actuator 200 which moves the abutment body 110.

For example, the pushing arrangement also comprises the rail 190 and a slide 210 slidingly associated with the rail according to a sliding axis parallel (e.g. coincident) to the predetermined pushing direction B. The abutment body is rigidly integral with the slide, with no residual degrees of freedom, which slide is driven by the linear actuator sliding relative to the rail to bring the abutment surface into the first and second positions.

The movement arrangement, the gripping arrangement and the pushing arrangement are synchronised in such a way that when, during the movement from the first point to the second point, the support element is at a predetermined distance from the third point (distance which can be zero or greater than zero), the drive of the gripping body moves the gripping body from the first position to the second position and then the pushing body is driven to bring the abutment surface from the first position to the second position.

For the operation of the unloading apparatus 40e defined hitherto, i.e. of the different embodiments of apparatuses defined hitherto, not all the characteristics of the support elements discussed above are required, but it is sufficient that the support element comprises:
a plurality of hooks capable of penetrating the portion of meat,
a bar to which said hooks are rigidly connected by means of a connection body comprising a first face, from which said needles rise, and a second face facing in the opposite direction to the first face, and
a grasping appendage rising from the second face in at least a direction away from the first face and from the second face.

For example, the unloading apparatus 40e in fact has support elements according to the embodiment 45b and the gripping body comprises a plurality of hooks or pins 140e adapted to be inserted into said recesses. However, the described drive may also be used, with slight modifications, in all the other embodiments of the support elements, comprising the one that requires grippers to grasp the grasping portion.

Another feature that takes advantage of the peculiarities of the support elements may be the fact that the pushing direction B is parallel to the moving-away direction along which the grasping portion extends. In other words, the pushing direction B is parallel to the longitudinal axes K of the needles. In particular, such parallelism refers to when the grasping appendage is grasped by the gripping body.

The apparatus may also comprise the pushing body 150 as explained above.

FIGS. 36 and 37 show a further embodiment of a support element 45o. Such embodiment differs from the others in that it additionally has a partition 66 that protrudes from the connection body 60 in the direction moving away from the bar, so as to prevent the portion of meat, when it is pierced by the hooks 55 and touches the first face 65 of the connection body, from protruding towards the grasping appendage, potentially hindering the grasping of the grasping appendage. In particular, the partition 66 extends, in the direction moving away from the bar, from a portion of the connection body from which the hooks 55 and the grasping appendage, or appendages, 75 rise. Furthermore, the partition has a free end placed at a distance from the bar (from the longitudinal axis of the bar) greater than a distance from the bar (from the longitudinal axis of the bar) with respect to the portions of the connection body from which the hooks and the grasping appendage (or appendages) extend.

In the embodiment shown, the partition is configured as a flat plate, i.e. a plurality of flat plates, extending from said portion of the connection body and having a first major face and a second major face, which are transverse to the longitudinal axes K of the needles 55. For example, the major faces of said flat plate (i.e. each flat plate) of the partition are coplanar to the first major face and the second major face of the connection body.

When the bar is moved along a substantially horizontal direction, the partition (i.e. its free end) protrudes at a lower vertical quota than a minimum vertical quota of the grasping appendage or hooks 55 (according to which one of them is the lowermost).

The partition is only shown in an embodiment deriving from the embodiment of FIGS. 19-21, however, it may be applied to all the embodiments described and/or shown of the support element.

The operation of the unloading apparatus according to the invention is as follows.

As an example of the different embodiments of the unloading apparatus implementing the first method, the unloading apparatus 40a will be hereinafter described according to FIGS. 1-5.

Unloading operations begin with the support elements already taken over by the movement arrangement 120. In particular, the longitudinal ends of the bars of the support elements are moved on the transport surface defined by the chains of the movement arrangement.

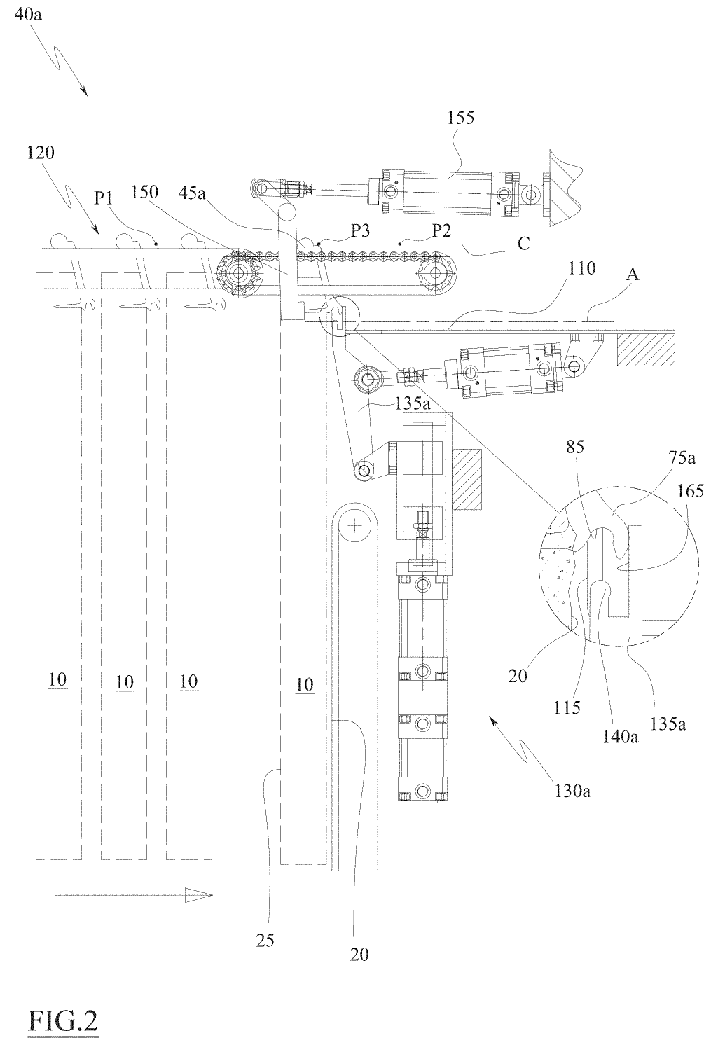

From the first point of the predefined trajectory C, the support elements are moved by acting only on the bars towards the second point P2 and just before the bar of a support element reaches the third point P3, the gripping body 135a is moved to the third position so that the grasping appendage 75a contacts the abutment surface 165 (see FIG. 2).

Then, the gripping body is brought from the third position to the first position, thus grasping the grasping appendage, i.e. inserting the hook 140a into the recess 85 (see FIG. 3).

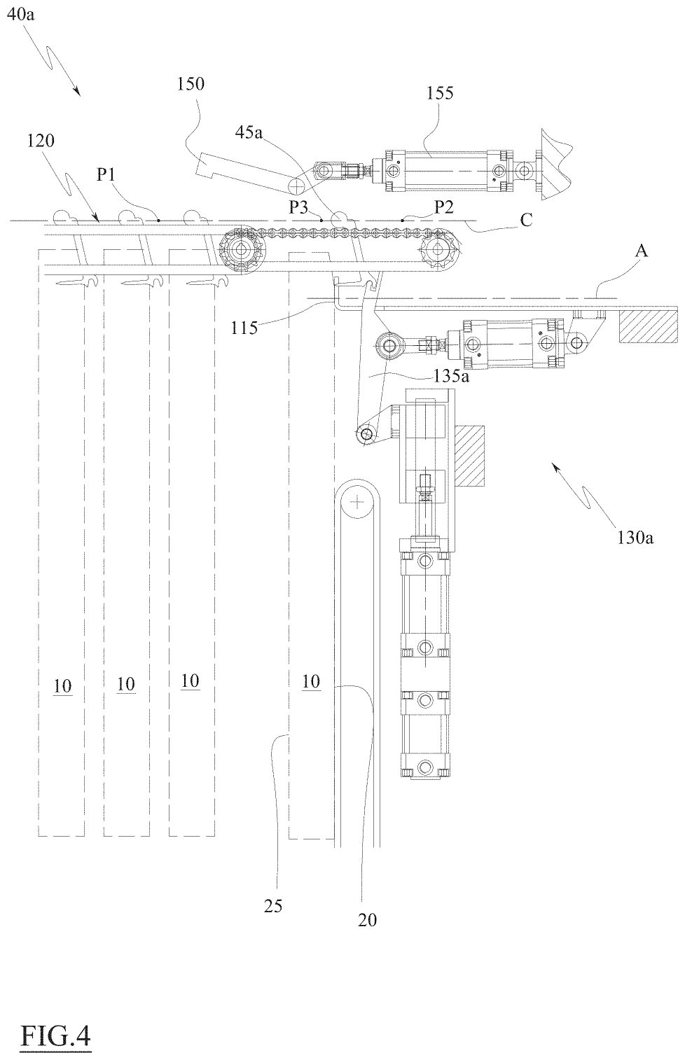

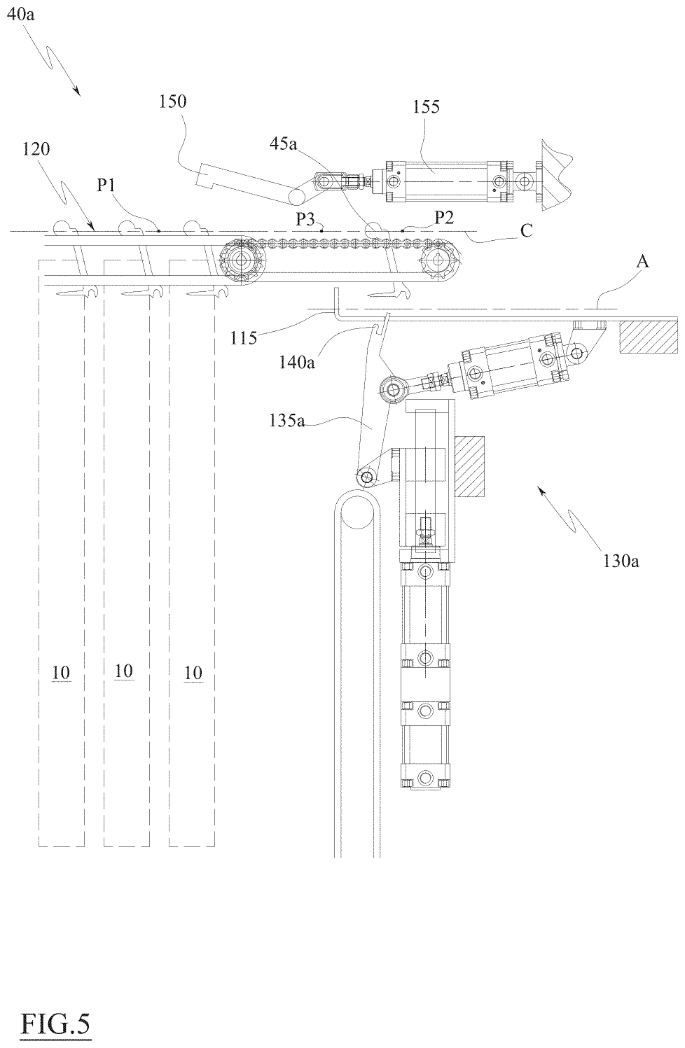

Once the hook of the gripping body is inserted, the gripping body is pulled by its drive arrangement along the predetermined extraction direction A, pulling with it the grasping appendage and then the support element. Since the portion of meat is unable to follow the support element along this predetermined extraction direction due to the abutment surface 115 that is interposed between the portion of meat and the gripping body, the portion of meat is thus pulled off from the hooks, i.e. from the needles (FIGS. 4 and 5).

In case of unloading apparatuses comprising the gripping body hinged to a single respective drive and held by the spring element, such as, for example, the embodiment 40d, the main difference consists in that the hooking of the support element by the gripping element takes place by advancing the support element with the drive unit and possibly thanks to the pushing body while the gripping body is already in the first position.

In the case of the unloading apparatus 40e implementing the second method, the steps are similar to those previously described, with the main difference that after grasping (in this case, the abutment surfaces are not exploited due to the shape of the support element), the grasping appendage is not pulled away from the abutment surface, but it is the abutment surface 115 that is pulled away from the gripping body, i.e. from the grasping appendage, which remains substantially stationary while pushing the portion of meat by creating a pressure at the first major face 20 and thus pulling it off the hooks, i.e. the needles.

We take this opportunity to specify that when reference is made in this specification to a single body or monolithic construction, the element is intended to be obtained by solidification of a single casting or injection of material in a mould (and possible subsequent processing by removing material and/or bending).

It should also be noted that grabbing a body means connecting to said body in such a way as to be able to transfer it a force, in this case a pulling force. In case the gripping body of the grasping body is the gripper (embodiment wherein the grasping appendage is a flat, seamless plate), grasping takes place by clamping the flat plate and transmitting the pulling force through friction.

In case the gripping body of the grasping appendage is the hook-shaped body (embodiments wherein the grasping appendage comprises recesses or slots), grasping takes place by inserting a portion of the hook-shaped body into the recess or slot, which are overall shaped so as not to allow the hook-shaped body to slip out when applying the pulling force, which is transmitted to the recess or slot by a pressure applied by the hook-shaped body.

The invention thus conceived is susceptible to several modifications and variations, all falling within the scope of the inventive concept.

In addition, all details can be replaced by other technically equivalent elements.

In practice, the materials used, as well as the contingent shapes and sizes, can be whatever according to the requirements without for this reason departing from the scope of protection of the following claims.

1. A method for unhooking a portion of meat from a support element to which the portion of meat is hooked, said support element comprising:
a plurality of hooks by means of which the portion of meat is hooked to the support element,
a bar to which said hooks are rigidly connected by a connection body, which comprises a first face, from which said hooks rise, and a second face facing in the opposite direction to the first face, and
a grasping appendage rising from the second face in at least a direction away from the first face and from the second face,
said method comprising the steps of:
pulling the grasping appendage in a predetermined extraction direction (A), and
holding the portion of meat, or pushing the portion of meat in a direction opposite to the predetermined extraction direction, at the same time as the step of pulling the grasping appendage in the predetermined extraction direction, while completely pulling the hooks off the portion of meat.

2. The method according to claim 1, wherein the step of pulling the grasping appendage in the predetermined extraction direction is performed by means of an automated gripping arrangement.

3. The method according to claim 1, wherein the step of pulling the grasping appendage is preceded by the steps of:
preparing an abutment body defining an abutment surface,
bringing a section of a face of the portion of meat contacting the first face of the connection element into contact with the abutment surface by acting on the bar and/or on the grasping appendage, and wherein the predetermined extraction direction in which the grasping appendage is pulled is away from the abutment surface,
and wherein the steps of holding the portion of meat, or pushing the portion of meat in a direction opposite to the predetermined direction in which the grasping appendage is pulled, comprise respectively the step of keeping the abutment surface fixed at a predetermined position in space and the step of moving the abutment surface in a direction opposite to the direction along which the grasping appendage is pulled.

4. The method according to claim 3, wherein the step of bringing a section of the face of the portion of meat contacting the first face of the connection element into contact with the abutment surface by acting on the bar and/or on the grasping appendage is performed by an automated movement arrangement (120) configured to move the support element acting on the bar and/or by the automated gripping arrangement configured to grasp and pull the grasping appendage.

5. The method according to claim 3, wherein the step of bringing a section of a face of the portion of meat contacting the first face of the connection element into contact with the abutment surface by acting on the bar and/or on the grasping appendage is preceded by the step of moving the support element by acting on its bar, in a predetermined movement direction along a predefined trajectory transverse to a lying plane of the abutment surface and placed at a predetermined distance from the abutment surface such that the portion of meat moved along said trajectory, by the support element to which the portion of meat is hooked, arrives at a section thereof to contact the abutment surface with the face of the portion of meat in contact with the first face of the connection element, said trajectory comprising a first point, upstream of the abutment surface with respect to the predetermined movement direction, and a second point downstream of the abutment surface with respect to the predetermined movement direction along the predefined trajectory, and during the movement the second face of the connection element is kept facing the second point.

6. The method according to claim 5, wherein the predetermined extraction direction in which the grasping appendage is pulled is in the direction of approach to the second point of the predetermined trajectory.

7. A method for unhooking a portion of meat from a support element to which the portion of meat is hooked, said support element comprising:
a plurality of hooks by means of which the portion of meat is hooked to the support element,
a bar to which said hooks are rigidly connected by a connection body, which comprises a first face, from which said hooks rise, and a second face facing in the opposite direction to the first face, and
a grasping appendage rising from the second face in at least a direction away from the first face and from the second face,
said method comprising the steps of:
holding the grasping appendage,
pushing the portion of meat in a predetermined pushing direction away from the hooks of the support element, at the same time as the step of holding the grasping appendage, by completely pulling the hooks off the portion of meat.

8. An unloading apparatus of an automated type for portions of meat configured to unhook a portion of meat from a support element, said support element comprising:
a plurality of hooks by means of which the portion of meat is hooked to the support element,
a bar to which said hooks are rigidly connected by a connection body, which comprises a first face, from which said hooks rise, and a second face facing in the opposite direction to the first face, and
a grasping appendage rising from the second face in at least a direction away from the first face and from the second face,
said unloading apparatus being provided with:
an abutment body defining an abutment surface,
a movement arrangement of the support elements, which is of an automated type and is configured to move at least one support element along a predetermined trajectory transverse to a lying plane of the abutment surface and placed at a predetermined distance from the abutment surface such that the moved portion of meat associated with the support element moved along said trajectory comes into contact with the abutment surface, and wherein the movement arrangement is configured to move the support element along said trajectory in a predetermined direction, at least from a first point of the trajectory, upstream of the abutment surface with respect to the predetermined movement direction along the predetermined trajectory, to a second point of the trajectory, downstream of the abutment surface with respect to the movement direction along the predetermined trajectory and wherein the movement arrangement is configured to keep the second face of the connection body, facing the second point,
a gripping arrangement positioned in proximity to the abutment surface and provided with a gripping body configured to grasp the grasping appendage and a drive of the gripping body configured to move the gripping body into a grasping position, in which the gripping body grasps the grasping portion, and to subsequently pull the gripping body, in a predetermined extraction direction (A) that is away from the abutment surface, extracting the hooks from the portion of meat that is held in contact with the abutment surface.

9. The apparatus according to claim 8, wherein the gripping arrangement is configured to only grasp the grasping appendage.

10. The apparatus according to claim 8, comprising a sensor configured to monitor a parameter indicative of the presence of the support element in proximity to a lying plane of the abutment surface, and an electronic control and command unit operatively connected to said sensor and to the gripping arrangement and configured to activate the drive of the gripping arrangement so that it moves the gripping body into the grasping position when it detects through the sensor the presence of the support element at a predetermined distance from the abutment surface.
